(19) United States
(12) Patent Application Publication
(10) Pub. No.: US 2025/0345787 A1
(43) Pub. Date: Nov. 13, 2025

(54) DIAGNOSTIC TEST DEVICE WITH CAPILLARY GROOVES

(71) Applicant: Becton, Dickinson and Company, Franklin Lakes, NJ (US)

(72) Inventors: Patrick Truitt, New Freedom, PA (US); Ashlyn Young, Cary, NC (US); Edward Carrese, Monkton, MD (US); William Robb Hopper, Melbourne (AU); Gavin Rakesh Ramanathan, Melbourne (AU); Lachlan James Steele, Melbourne (AU)

(73) Assignees: Becton, Dickinson and Company, Franklin Lakes, NJ (US); Axxin Pty Ltd, Fairfield (AU)

(21) Appl. No.: 19/280,681

(22) Filed: Jul. 25, 2025

Related U.S. Application Data
(63) Continuation of application No. PCT/US2024/016632, filed on Feb. 21, 2024.
(60) Provisional application No. 63/486,931, filed on Feb. 24, 2023.

(51) Int. Cl. B01L 3/00

(52) U.S. Cl. CPC B01L 3/502; B01L 2200/0689; B01L 2200/16; B01L 2400/0406

(57) ABSTRACT

A diagnostic test device to perform a test on a biological or environmental sample is provided. In one aspect, the diagnostic test device includes a chamber configured to receive a fluid from a sample preparation reservoir at a first section of the chamber, and one or more capillary grooves along an inner surface of the chamber. The capillary grooves are configured to promote flow of the fluid toward a second section of the chamber. Embodiments of the diagnostic test reservoir can increase an amount of sample available to an assay reaction, which in one example embodiment occurs within a volume of fluid in the second section of the chamber.

### CROSS REFERENCE TO RELATED APPLICATIONS

This application is a continuation of PCT International Application No. PCT/US2024/016632, filed Feb. 21, 2024, which claims the benefit of U.S. Provisional Application No. 63/486,931, filed Feb. 24, 2023, each of which is hereby incorporated by reference in its entirety.

### BACKGROUND

### Technological Field

The present disclosure relates to optimizing transfer of a sample solution within a consumable for diagnostic tests, and in particular nucleic-acid diagnostic tests. More particularly, the present disclosure relates to devices and methods for optimizing a volume of sample solution that moves from a sample preparation reservoir into a portion of a diagnostic test reservoir configured to receive heat and light energy for detection of an analyte of interest in the sample solution.

### Description of the Related Technology

The amplification of nucleic acids is important in many fields, including medical, biomedical, environmental, veterinary and food safety testing. Example methods of nucleic acid amplification include polymerase chain reaction (PCR) amplification and isothermal amplification.

Nucleic acid amplification can generate a large number of copies of a target genetic sequence in a test solution. Specific markers can be designed to link to the target sequences as part of a test assay. Once bound, the markers can provide a detectable signal, for example an optical signal, from the test solution. Changes in an optical signal can include changes in the color, opacity, bioluminescence, and/or fluorescence of the test solution. In the case of a fluorescence marker beacon, each marker molecule may be configured with a florescence quencher in close proximity to a fluorescence atom or arrangement of atoms. This marker molecule can be configured such that when selectively bound to a target nucleic acid sequence, the quencher and fluorophore are separated and a fluorescence signal can then be detected by the action of the fluorophore. In this arrangement, the florescence intensity of the target solution is indicative of the relative amount of target genetic material in the test solution. This signal can then be used to form the basis of a diagnostic test to determine the presence or absence and the relative quantity of the target material, or analyte of interest, in the sample under test.

Two or more markers may be included in a single test well which each may provide optical output based on bonding to different target nucleic acid sequences. Different sensors, or a sensor with two or more selective outputs can be used in conjunction with these two or more markers. For example, in a two-channel system, two different fluorophores may be used that can be detected by two different fluorescence sensors configured to detect emissions in the respective frequency ranges of each fluorophore. Thus, the two channels may be discriminated.

Such an approach can be used to provide a control channel. In an example control channel, test assay chemistry is configured such that the control target, for example a synthetic nucleic acid sequence, should always be present if the test process is run correctly. The output of the control channel may be used to confirm that a test process has been run correctly by the system and/or to confirm the validity of test results obtained by other channels measured by the system. This approach can be applied to a test of more than one target sequence within a single test well.

Multiple test wells may be used. Each well may run different amplification chemistries and/or a different set of target markers. Control channels, as discussed above, may be operated in one or more wells.

Consumable diagnostic test devices implementing multiple test wells can be implemented. Consumable diagnostic test devices can be disposable, single-use devices targeted to the Point of Care market, where case of use, simplicity, and cost-per-consumable are important considerations. Consumables can be formed of polypropylene, a plastic that is easily molded to form mass-produced parts having high chemical resistance, and which is readily available at relatively low cost. Polypropylene also has relatively low water vapor permeability, which may facilitate long term storage of dry reagents within a polypropylene consumable. In nucleic acid-based diagnostic tests, elution lysis buffer (ELB) is commonly provided to elute a test specimen from a sample collection device, such as a swab, and to release genomic material from the test specimen for molecular diagnostic testing. ELB is frequently a water-based solution. Consequently, the ELB's characteristically high polarity can interact with the relatively low polarity polypropylene of a consumable diagnostic test in a way that inhibits test performance. For example, droplets of the ELB may adhere to a surface formed of polypropylene due to poor wetting of the polypropylene, causing a smaller quantity of ELB to be available for testing. As another example, a droplet of the ELB that has adhered to the wall during an early portion of a reaction may subsequently fall to the bottom of the reaction chamber, altering the concentration of reactants (including but not limited to analytes of interest and reagents) and potentially causing a change in detectable output. Accordingly, there is a need for improvement in many aspects of consumable diagnostic tests, and in particular nucleic acid-based diagnostic tests that use water-based solutions to extract and test nucleic acids of interest.

### SUMMARY

In one non-limiting embodiment, a diagnostic test device is provided. The diagnostic test device includes a cartridge body including a sample preparation reservoir, and a diagnostic test reservoir coupled to the cartridge body. The diagnostic test reservoir includes at least one chamber configured to receive a fluid from the sample preparation reservoir at a first section of the at least one chamber, and one or more capillary grooves along an inner surface of the at least one chamber. The one or more capillary grooves are configured to promote flow of the fluid toward a second section of the at least one chamber.

The one or more capillary grooves can be configured to inhibit droplets of the fluid from adhering to the inner surface in the first section of the at least one chamber when the fluid is dispensed into the at least one chamber from the sample preparation reservoir. The one or more capillary grooves can be configured to increase a volume of the fluid that is collected in the second section of the at least one chamber.

The at least one chamber can be configured to transmit fluorescence signals. The flow of fluid can be downward from the first section toward the second section. The second section can include a closed end.

The diagnostic test device can include a seal between the sample preparation reservoir and the at least one chamber, the seal configured to prevent movement of the fluid between the sample preparation reservoir and the at least one chamber. The diagnostic test device can include a dispensing mechanism configured to break the seal to allow movement of the fluid from the sample preparation reservoir into the at least one chamber.

The diagnostic test device can include the fluid. The fluid can be a water-based buffer solution. The water-based buffer solution can be at least one of an RBCC, a GRBS, and SDS.

The sample preparation reservoir can be configured to receive a test sample. The sample preparation reservoir can be configured to receive a swab including the test sample. At least a portion of the fluid and at least a portion of the test sample can be configured to move from the sample preparation reservoir to the at least one chamber.

The at least one chamber can include two diagnostic test reservoirs, each of the diagnostic test reservoirs including one or more capillary grooves. The at least one chamber can include a plastic. The plastic can be polypropylene. The at least one chamber can be coupled to the cartridge body via an ultrasonic weld.

The one or more capillary grooves can be configured to facilitate movement of the fluid into contact with a lyophilized reagent in the second section of the at least one chamber. The lyophilized reagent can include nucleic acid amplification primers and a nucleic acid amplification detection probe.

The one or more capillary grooves can include a plurality of spaced apart valleys along the inner surface of the at least one chamber, each of the spaced apart valleys including a curved cross-section. The curved cross-section includes a smooth arc.

Each of the plurality of spaced apart valleys can include three inflection points. Each of the plurality of spaced apart valleys can include three curvatures. Each of the plurality of spaced apart valleys can include two convex portions separated by a concave portion. The transitions between the inner surface of the at least one chamber and the plurality of spaced apart valleys can include rounded edges. A valley of the plurality of spaced apart valleys can include a semicircular or semielliptical cross-sectional shape. The plurality of spaced apart valleys can be separated by a planar portion of the inner surface of the at least one chamber.

A portion of the inner surface in the second section of the at least one chamber can form a continuous circumferential surface. A portion of the inner surface in the second section of the at least one chamber can form a continuously curved surface. The inner surface can form a closed perimeter in the at least one chamber. A portion of the inner surface can terminate in a smooth arc in the second section of the at least one chamber. A portion of the inner surface can be continuous between the first section of the at least one chamber and the smooth arc in the second section of the at least one chamber.

The at least one chamber can include a window region below ends of the plurality of spaced apart valleys. The at least one chamber can include a window region that does not include a valley of the plurality of spaced apart valleys.

A valley of the plurality of spaced apart valleys can be tapered along a portion of its height. The valley of the plurality of spaced apart valleys can begin tapering at a height between the first section and the second section. An end of a valley of the plurality of spaced apart valleys can have a semicircular profile. An end of a valley of the plurality of spaced apart valleys can have a tapered profile.

A first valley of the plurality of spaced apart valleys can extend a first distance toward the second section of the at least one chamber and a second valley of the plurality of spaced apart valleys can extend a second distance toward the second section of the at least one chamber, the second distance longer than the first distance. A valley of the plurality of spaced apart valleys can have a different cross-sectional shape in the first section of the at least one chamber than the cross-sectional shape at an end of the valley.

In another non-limiting example, a method of performing a diagnostic test using a diagnostic test device is provided. The diagnostic test device includes a sample preparation reservoir and a diagnostic test reservoir. The method includes dispensing a fluid from the sample preparation reservoir into at least one chamber of the diagnostic test reservoir, one or more capillary grooves along an inner surface of the at least one chamber. The one or more capillary grooves are configured to promote flow of the fluid toward a section of the at least one chamber. The method also includes performing an amplification reaction in the at least one chamber. The method further includes detecting a presence or absence of an analyte of interest in the at least one chamber.

The method can further include adding a test sample to the fluid in the sample preparation reservoir before dispensing the fluid into the at least one chamber. The method can further include rehydrating a lyophilized reagent in the at least one chamber with the fluid dispensed from the sample preparation reservoir. Performing an amplification reaction can include applying heat to the at least one chamber. Detecting the presence or absence of the analyte of interest can include detecting changes in a fluorescence emission indicative of a test result, the fluorescence emission exiting the at least one chamber through a portion of a wall of the chamber, the portion of the wall not including a capillary groove. Dispensing the fluid can include collecting the fluid in the section of the at least one chamber, and the one or more capillary grooves can be configured to increase a volume of the fluid that collects in the section of the at least one chamber. The method can further include flowing the fluid down the one or more capillary grooves towards the section of the at least one chamber.

The one or more capillary grooves can include a plurality of spaced apart valleys along the inner surface of the at least one chamber, each of the plurality of spaced apart valleys including a curved cross-section.

The curved cross-section can include a smooth arc. Each of the plurality of spaced apart valleys can include three inflection points. Each of the plurality of spaced apart valleys can include three curvatures. Each of the plurality of spaced apart valleys can include two convex portions separated by a concave portion.

Transitions between the inner surface of the at least one chamber and the plurality of spaced apart valleys can include rounded edges. A valley of the plurality of spaced apart valleys can include a semicircular or semielliptical cross-sectional shape. The plurality of spaced apart valleys can be separated by a planar portion of the inner surface of the at least one chamber.

Embodiments provided herein include the following numbered Embodiments:

1. A diagnostic test device comprising:
a cartridge body comprising a sample preparation reservoir; and
a diagnostic test reservoir coupled to the cartridge body, the diagnostic test reservoir comprising at least one chamber configured to receive a fluid from the sample preparation reservoir at a first section of the at least one chamber, one or more capillary grooves along an inner surface of the at least one chamber, the one or more capillary grooves configured to promote flow of the fluid toward a second section of the at least one chamber.

2. The diagnostic test device of embodiment 1, wherein the one or more capillary grooves are configured to inhibit droplets of the fluid from adhering to the inner surface in the first section of the at least one chamber when the fluid is dispensed into the at least one chamber from the sample preparation reservoir.

3. The diagnostic test device of embodiment 1 or 2, wherein the one or more capillary grooves are configured to increase a volume of the fluid that is collected in the second section of the at least one chamber.

4. The diagnostic test device of any of embodiments 1 to 3, wherein the at least one chamber is configured to transmit fluorescence signals.

5. The diagnostic test device of any of embodiments 1 to 4, wherein the flow of fluid is downward from the first section toward the second section.

6. The diagnostic test device of any of embodiments 1 to 5, wherein the second section comprises a closed end.

7. The diagnostic test device of any of embodiments 1 to 6, further comprising a seal between the sample preparation reservoir and the at least one chamber, the seal configured to prevent movement of the fluid between the sample preparation reservoir and the at least one chamber.

8. The diagnostic test device of embodiment 7, further comprising a dispensing mechanism configured to break the seal to allow movement of the fluid from the sample preparation reservoir into the at least one chamber.

9. The diagnostic test device of any of embodiments 1 to 8, wherein the diagnostic test device includes the fluid, and wherein the fluid comprises a water-based buffer solution.

10. The diagnostic test device of embodiment 9, wherein the water-based buffer solution comprises at least one of an RBCC, a GRBS, and SDS.

11. The diagnostic test device of embodiment 9, wherein the sample preparation reservoir is configured to receive a test sample.

12. The diagnostic test device of embodiment 11, wherein the sample preparation reservoir is configured to receive a swab comprising the test sample, and wherein at least a portion of the fluid and at least a portion of the test sample is configured to move from the sample preparation reservoir to the at least one chamber.

13. The diagnostic test device of any of embodiments 1 to 12, wherein the at least one chamber comprises two diagnostic test reservoirs, each of the diagnostic test reservoirs comprising one or more capillary grooves.

14. The diagnostic test device of any of embodiments 1 to 13, wherein the at least one chamber comprises a plastic.

15. The diagnostic test device of embodiment 14, wherein the plastic comprises polypropylene.

16. The diagnostic test device of embodiment 14 or 15, wherein the at least one chamber is coupled to the cartridge body via an ultrasonic weld.

17. The diagnostic test device of any of embodiments 1 to 16, wherein the one or more capillary grooves are configured to facilitate movement of the fluid into contact with a lyophilized reagent in the second section of the at least one chamber.

18. The diagnostic test device of embodiment 17, wherein the lyophilized reagent comprises nucleic acid amplification primers and a nucleic acid amplification detection probe.

19. The diagnostic test device of any of embodiments 1 to 18, wherein the one or more capillary grooves comprise a plurality of spaced apart valleys along the inner surface of the at least one chamber, each of the spaced apart valleys comprising a curved cross-section.

20. The diagnostic test device of embodiment 19, wherein the curved cross-section comprises a smooth arc.

21. The diagnostic test device of embodiment 19 or 20, wherein each of the plurality of spaced apart valleys comprises three inflection points.

22. The diagnostic test device of any of embodiments 19 to 21, wherein each of the plurality of spaced apart valleys comprises three curvatures.

23. The diagnostic test device of any of embodiments 19 to 22, wherein each of the plurality of spaced apart valleys comprises two convex portions separated by a concave portion.

24. The diagnostic test device of embodiment 19 or 20, wherein the transitions between the inner surface of the at least one chamber and the plurality of spaced apart valleys comprise rounded edges.

25. The diagnostic test device of any of embodiments 19 to 24, wherein a valley of the plurality of spaced apart valleys comprises a semicircular or semielliptical cross-sectional shape.

26. The diagnostic test device of any of embodiments 19 to 25, wherein the plurality of spaced apart valleys are separated by a planar portion of the inner surface of the at least one chamber.

27. The diagnostic test device of any of embodiments 19 to 26, wherein a portion of the inner surface in the second section of the at least one chamber forms a continuous circumferential surface.

28. The diagnostic test device of any of embodiments 19 to 27, wherein a portion of the inner surface in the second section of the at least one chamber forms a continuously curved surface.

29. The diagnostic test device of any of embodiments 19 to 28, wherein the inner surface forms a closed perimeter in the at least one chamber.

30. The diagnostic test device of any of embodiments 19 to 29, wherein a portion of the inner surface terminates in a smooth arc in the second section of the at least one chamber.

31. The diagnostic test device of embodiment 30, wherein a portion of the inner surface is continuous between the first section of the at least one chamber and the smooth arc in the second section of the at least one chamber.

32. The diagnostic test device of any of embodiments 19 to 31, wherein the at least one chamber further comprises a window region below ends of the plurality of spaced apart valleys.

33. The diagnostic test device of any of embodiments 19 to 31, wherein the at least one chamber further comprises a window region that does not include a valley of the plurality of spaced apart valleys.

34. The diagnostic test device of any of embodiments 19 to 33, wherein a valley of the plurality of spaced apart valleys is tapered along a portion of its height.

35. The diagnostic test device of embodiment 34, wherein the valley of the plurality of spaced apart valleys begins tapering at a height between the first section and the second section.

36. The diagnostic test device of any of embodiments 19 to 34, wherein an end of a valley of the plurality of spaced apart valleys has a semicircular profile.

37. The diagnostic test device of any of embodiments 19 to 35, wherein an end of a valley of the plurality of spaced apart valleys has a tapered profile.

38. The diagnostic test device of any of embodiments 19 to 37, wherein a first valley of the plurality of spaced apart valleys extends a first distance toward the second section of the at least one chamber and a second valley of the plurality of spaced apart valleys extends a second distance toward the second section of the at least one chamber, the second distance longer than the first distance.

39. The diagnostic test device of any of embodiments 19 to 38, wherein a valley of the plurality of spaced apart valleys has a different cross-sectional shape in the first section of the at least one chamber than the cross-sectional shape at an end of the valley.

40. A method of performing a diagnostic test using a diagnostic test device, the diagnostic test device comprising a sample preparation reservoir and a diagnostic test reservoir, the method comprising:
dispensing a fluid from the sample preparation reservoir into at least one chamber of the diagnostic test reservoir, one or more capillary grooves along an inner surface of the at least one chamber, the one or more capillary grooves configured to promote flow of the fluid toward a section of the at least one chamber;
performing an amplification reaction in the at least one chamber; and
detecting a presence or absence of an analyte of interest in the at least one chamber.

41. The method of embodiment 40, further comprising adding a test sample to the fluid in the sample preparation reservoir before dispensing the fluid into the at least one chamber.

42. The method of embodiment 40 or 41, further comprising rehydrating a lyophilized reagent in the at least one chamber with the fluid dispensed from the sample preparation reservoir.

43. The method of any of embodiments 40 to 42, wherein performing an amplification reaction comprises applying heat to the at least one chamber.

44. The method of any of embodiments 40 to 43, wherein detecting the presence or absence of the analyte of interest comprises detecting changes in a fluorescence emission indicative of a test result, the fluorescence emission exiting the at least one chamber through a portion of a wall of the chamber, the portion of the wall not including a capillary groove.

45. The method of any of embodiments 40 to 44, wherein dispensing the fluid comprises collecting the fluid in the section of the at least one chamber, and wherein the one or more capillary grooves are configured to increase a volume of the fluid that collects in the section of the at least one chamber.

46. The method of any of embodiments 40 to 45, further comprising flowing the fluid down the one or more capillary grooves towards the section of the at least one chamber.

47. The method of any of embodiments 40 to 46, wherein the one or more capillary grooves comprise a plurality of spaced apart valleys along the inner surface of the at least one chamber, each of the plurality of spaced apart valleys comprising a curved cross-section.

48. The method of embodiment 47, wherein the curved cross-section comprises a smooth arc.

49. The method of embodiments 47 or 48, wherein each of the plurality of spaced apart valleys comprises three inflection points.

50. The method of any of embodiments 47 to 49, wherein each of the plurality of spaced apart valleys comprises three curvatures.

51. The method of any of embodiments 47 to 50, wherein each of the plurality of spaced apart valleys comprises two convex portions separated by a concave portion.

52. The method of any of embodiments 47 to 51, wherein the transitions between the inner surface of the at least one chamber and the plurality of spaced apart valleys comprise rounded edges.

53. The method of any of embodiments 47 to 52, wherein a valley of the plurality of spaced apart valleys comprises a semicircular or semielliptical cross-sectional shape.

54. The method of any of embodiments 47 to 53, wherein the plurality of spaced apart valleys are separated by a planar portion of the inner surface of the at least one chamber.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 illustrates an exploded view of components of an example diagnostic test device according to the present disclosure.

FIG. 2A illustrates the example diagnostic test device of FIG. 1 with a dispense cap.

FIG. 2B illustrates the example diagnostic test device of FIG. 1 with a transportation cap.

FIGS. 3A-3C illustrate views of the test container shown in FIGS. 1-2B.

FIG. 3D plots the relationship between capillary groove radius and contact angle of liquid according to an embodiment of the present disclosure.

FIG. 3E illustrates a view of an example test container that does not include capillary grooves.

FIGS. 3F-3H illustrate views of the test container shown in FIGS. 1-2B.

FIGS. 3I-3J illustrate views of an example test container according to an embodiment of the present disclosure.

FIG. 4A illustrates a view of a cartridge body of the embodiment depicted in FIG. 1.

FIG. 4B illustrates a view of cylindrical chambers of the embodiment depicted in FIG. 4A.

FIG. 4C illustrates a cross-sectional view of the cylindrical chambers of the embodiment depicted in FIG. 4A.

FIGS. 4D and 4E illustrate cross-sectional views of the cartridge body of the embodiment depicted in FIG. 4A.

FIG. 4F illustrates a side view of the cartridge body of the embodiment depicted in FIG. 4A.

FIG. 4G illustrates a top-down view of the cartridge body of the embodiment depicted in FIG. 4A.

FIG. 4H illustrates an enlarged view of the test container of FIG. 1.

FIG. 5A illustrates the dispense cap of FIG. 1.

FIG. 5B illustrates a cross-sectional view of another dispense cap according to the present disclosure.

FIG. 5C illustrates a cross-sectional view of the dispense cap of FIG. 5B engaged with the cartridge body of the embodiment of FIG. 1.

FIG. 5D illustrates the interaction of a locking tab of the dispense cap of FIG. 1 with a locking thread of the cartridge body of FIG. 1.

FIG. 5E illustrates the interaction of an overtravel tab of the dispense cap of FIG. 1 with a blocking flange of the cartridge body of FIG. 1.

FIG. 6A illustrates a side view of the dispensing mechanism of FIG. 1.

FIG. 6B illustrates an angled bottom view of the dispensing mechanism of FIG. 1.

FIGS. 6C and 6D illustrate an alternative embodiment of a sealing member according to the present disclosure.

FIGS. 6E and 6F illustrate top and bottom views, respectively, of the alternative embodiment of a sealing member depicted in FIGS. 6C and 6D.

FIG. 7A illustrates a cross-sectional view of the embodiment of FIG. 1, where the dispensing mechanism has been inserted into the sample preparation reservoir.

FIG. 7B illustrates a cross-sectional view of the embodiment of FIG. 1, where the dispensing mechanism has pierced the seal.

FIG. 7C illustrates a cross-sectional view of the embodiment of FIG. 1, where the sealing member has engaged the walls of the cylindrical chambers but has not pierced the seal.

FIGS. 7D and 7E illustrate a cross-sectional view of the embodiment of FIG. 1, where the dispensing mechanism has been fully inserted, and a predetermined amount of fluid has been dispersed to the diagnostic test reservoir. FIG. 7D is a view that shows the piercing members more closely than FIG. 7E, which shows the entire diagnostic test device.

FIG. 8 illustrates an example method for performing a diagnostic test using a diagnostic test device in accordance with the present disclosure.

FIG. 9 illustrates the diagnostic test device of FIG. 1 received in a portion of a diagnostic test apparatus.

FIGS. 10-18 illustrate views of an example diagnostic test device according to the present disclosure.

FIGS. 19A-19C illustrate examples of fogging or droplet formation in devices not including capillary grooves in accordance with the present disclosure.

### DETAILED DESCRIPTION

Embodiments of the present disclosure provide devices, systems, and methods capable of optimizing transfer of a solution, such as a sample solution, from one portion of a diagnostic test device to another portion of the device. The solution can include a high polarity liquid, such as a water-based solution, that tends to be retained on a surface formed of a low polarity material, such as a plastic surface, when the solution comes into contact with, or otherwise interacts with, the surface. The surface can include, for example, a surface of a component formed of polypropylene, and the solution may pass across or along the surface as it is being transferred within the diagnostic test device. Embodiments of the present disclosure include surfaces having one or more capillary grooves. The capillary grooves can be shaped and sized to promote flow, such as downward flow, of the solution. For example, embodiments of diagnostic test devices including capillary grooves according to the present disclosure can advantageously decrease the tendency of the solution to create droplets on the surface during transfer from one portion of the diagnostic test device to another portion of the device.

Reducing or eliminating a variable, uncontrolled, and/or inefficient transfer of the solution using embodiments of capillary grooves according to the present disclosure can increase a volume of the solution that is received in a portion of the diagnostic test device where testing occurs, thereby increasing an amount of sample available to an assay reaction. For example, embodiments of the present disclosure can advantageously increase a volume of solution that is transferred within a diagnostic test device from a sample preparation reservoir to a test reservoir, or a portion of a test reservoir, where heat and/or light energy are delivered to perform a diagnostic test. Advantageously, increasing the volume of solution that is reliably and consistently delivered to the test reservoir using embodiments of the present disclosure can increase the quantity of analyte of interest that is included in an assay or other test reaction, contributing to diagnostic test results having higher accuracy and specificity. In addition, increasing the volume of solution that is reliably and consistently delivered to the test reservoir using embodiments of the present disclosure can ensure reagents (such as dry reagents) in the test reservoir are reconstituted to a target concentration. For example, embodiments of the present disclosure can allow an assay to be designed and/or optimized assuming that a desired volume of solution is reliably and consistently delivered to an area of the test reservoir where reagents are reconstituted.

In many instances, the elution lysis buffer (ELB) used in diagnostic testing platforms is a water-based solution. Consumables used in diagnostic testing—such as but not limited to cartridges, tubes, or reaction chambers—are often formed of or include a plastic such as polypropylene or polyethylene. Plastics that are commonly implemented, such as polypropylene and polyethylene, are relatively low-polarity materials. Consequently, ELB's characteristic high polarity may cause beading on the surface of plastic components of consumables, such as a reaction chamber configured to receive a solution.

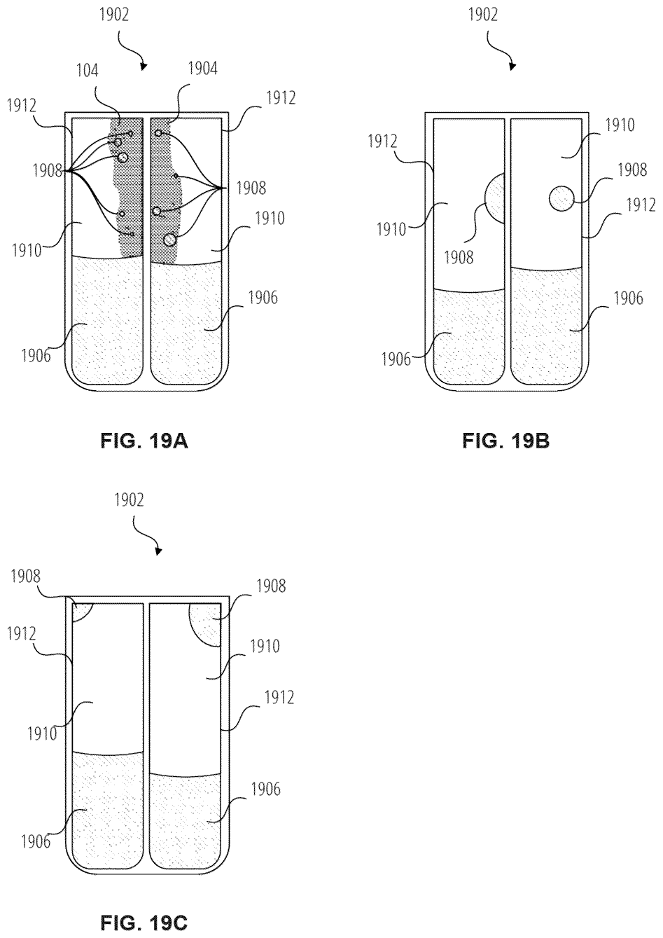

This interaction can cause less than an optimal quantity of solution to be available for testing in the diagnostic testing platform. For instance, ELB containing harvested patient sample may bead up and/or fog on the relatively low polarity plastic (in this non-limiting example polypropylene) on an inner surface of a reaction chamber wall. FIGS. 19A-19C illustrate this phenomenon. For example, a test reservoir 1902 may contain two reaction chambers 1910, each including an inner surface 1912. Though some of the ELB solution 1906 may be dispersed to the bottom of the reaction chamber 1910, some of the ELB solution may remain on the upper portion of the inner surfaces 1912, present in the form of droplets 1908 and fogging 1904. In these examples, the volume of ELB solution 1906 at the bottom of the reaction chamber 1910 is reduced because a portion of the ELB containing harvested patient sample is present in droplets 1908 or fogging 1904, rather than the volume of ELB solution 106 at the bottom of the reaction chamber 1910. In some cases, the droplets 1908 may not participate in reactions occurring at the bottom of the test reservoir 1902. In some cases, the droplets 1908 may adhere to the wall of the reaction chamber 1910, only to subsequently fall to the bottom of the test reservoir 1902 while a reaction is occurring, altering the concentration of reagents within the ELB solution 1906 while the reaction proceeds.

In FIG. 19A, the volume of ELB solution 1906 at the bottom of the reaction chambers 1910 is reduced because dispersed ELB is present in droplets 1908 and fogging 1904. ELB may be dispersed from the top of the reaction chambers 1910 and may fall or flow down to the bottom of the chambers 1910. Frequently, however, some volume of ELB remains on the upper portion of surface 1912 of chambers 1910, present as fogging 1904 and droplets 1908 as illustrated. The volume of ELB solution 106 at the bottom of each chamber 1910 is unequal due to unequal droplet formation and fogging between the two chambers 1910.

In FIG. 19B, a portion of the volume of ELB solution dispensed into the reaction chambers 1910 is present in the form of droplets 1908. The volume by which ELB solution 106 at the bottom of the chambers 1910 is reduced is related to the volume of droplets 1908. In FIG. 19B, the droplets are not of the same volume, so the ELB solution 1906 at the bottom of each chamber 1910 is unequal. As illustrated, the droplet 1908 on the surface 1912 of the left chamber 1910 is larger than the droplet 1908 on the surface 1912 of the right chamber 1910, and accordingly the volume of ELB solution 1906 at the bottom of the left chamber 1910 is less than the ELB solution 1906 at the bottom of the right chamber 1910.

In FIG. 19C, a volume of ELB solution 1906 at the bottom of the reaction chambers 1910 is reduced, because a portion of the ELB solution dispensed into the reaction chambers 1910 is present in droplets 108 formed at the top corners of the reaction chambers 1910. ELB solution may be dispensed from the top of the reaction chambers 1910 and may fall or flow down to the bottom of the chambers 1910. However, dispensed ELB solution frequently collects in the top corners, as shown in FIG. 19C. The geometry of the top corner of a reaction chamber 1910 provides two surfaces to which a droplet 1908 may adhere. Again, the formation of droplets 1908 reduces the volume of ELB solution 1906 present at the bottom of chambers 1910.

The droplet formation and/or fogging of the ELB solution may result in variability in the amount of sample-containing ELB solution introduced to the bottom of the reaction chamber, where there may be reagents for an assay reaction. The beading and/or fogging may also cause unintended variability in the amount of harvested test specimen available for the assay reaction. This, in turn, may cause inaccuracy in assay results since the amount (for example, volume) of test specimen available to the assay reaction is not well controlled. In addition, the beading and/or fogging may introduce variability in the concentration of reagents reconstituted in the reaction chamber, potentially leading to inconsistent or inaccurate assay results. These variability issues may be particularly acute in instances where the test specimen is delivered from one reservoir to another reservoir, such as reaction chamber 1910, in a way that exposes the ELB solution to surfaces, such as inner surfaces 1912 of reaction chamber 1910, formed of plastic.

In some instances, a sample present in the ELB solution may include genomic material. Beading and/or fogging of ELB solution may affect the amount of available genomic material, such as DNA or RNA, introduced to an amplification reaction, for example. For example, beading and/or fogging of the ELB solution can decrease the amount of genomic material present at a location in the reaction chambers 1910, for example the bottom of the reaction chambers 1910, where an amplification reaction within the reaction chambers 1910 occurs.

As noted above, in addition to decreasing sample variability, it may be desirable for ELB dispense volumes to be consistent to ensure that lyophilized reagents within the reaction chamber are reconstituted to a target concentration. As an example, beading and/or fogging leading to reduced ELB solution volume that is ultimately delivered to a target location in the diagnostic testing platform may cause lyophilized reagents to be reconstituted at a higher concentration than intended. Consequently, the assay involving these lyophilized reagents may not perform as intended (for example, the assay may yield inaccurate or inconsistent results).

Embodiments of the present disclosure provide devices, systems, and methods that can ensure more consistent ELB disperse volumes by minimizing or eliminating ELB beading on the inner surface of a target reservoir, such as a reaction chamber. For example, embodiments of the present disclosure provide for inclusion of capillary grooves within the reaction chamber, which can promote flow of droplets to the bottom of the reaction chamber. For embodiments where 100 μL of sample-containing fluid is dispersed to a diagnostic test reservoir, inclusion of capillary grooves may prevent 20-30 μL of the sample-containing fluid from being suspended on the walls of the diagnostic test reservoir. In other words, the capillary grooves increased the volume available for an assay reaction by 20-30 μL in these embodiments.

Embodiments of the present disclosure provide devices, systems, and methods can consistently transfer a predetermined volume of a solution, such as a fluid sample, from one portion of a diagnostic test device to another portion of the device, while also avoiding contamination of the solution and the external environment. The fluid sample can include a test sample in a buffer solution. In some cases, the fluid sample is amplification-ready when it is transferred from the first portion to the second portion of the device. The first portion of the diagnostic test device can include a sample preparation reservoir and the second portion of the diagnostic test device can include one or more test containers. For example, a predetermined amount of the fluid sample can be transferred from a sample processing reservoir to one or more test containers that include pre-stored amplification reagents. The one or more test containers can include surfaces having capillary grooves shaped and sized to promote flow, such as downward flow, of the fluid sample to a portion of the one or more test containers. For example, the capillary grooves can facilitate movement of the fluid sample to a portion of the one or more test containers where heat and/or light energy are delivered to perform a diagnostic test. The sample processing device can include dual internal cylinders, and the predetermined amount of the fluid sample can be dispensed through the dual internal cylinders to two test containers using a plunger. Advantageously, the two test containers can both include surfaces having capillary grooves, resulting in a predetermined volume of solution being reliably and consistently delivered to portions of both test containers where an assay or test reaction is performed. Prior to transfer of the fluid sample, the test containers are sealed to the external environment and the sample preparation reservoir and are thus protected from contaminants. After the transfer of the fluid sample, the test containers remain scaled to the external environment. Advantageously, the external environment is not exposed to the fluid sample, which can include hazardous components.

Diagnostic test devices of the present disclosure can dispense a predetermined amount of the fluid sample at the same time a sample-receiving end of the sample preparation reservoir is sealed. For example, the action of twisting a cap engaged to the sample-receiving end of the sample preparation reservoir also dispenses the fluid sample from the sample preparation reservoir to the test containers. Upon dispensing the fluid sample, the cap can lock, preventing access to the sample preparation reservoir and test containers, protecting them from contamination. Additional fluid flow between the sample preparation reservoir and the test containers is also prevented. The mechanism for dispensing the fluid sample while simultaneously sealing the diagnostic test device is uncomplicated, involving the movement of a single component within the sample processing reservoir. In particular, the dispensing mechanism includes a plunger configured to directly contact inner surfaces of the sample processing reservoir as the plunger translates within the sample preparation reservoir and a piercing end of the plunger pierces one or more seals separating the sample preparation reservoir and the test containers. Once dispensed, the fluid sample within the test containers may be assayed, using an amplification reaction for example, to determine the presence or absence of a target analyte. Advantageously, diagnostic test devices including surfaces having capillary grooves according to the present disclosure can reliably dispense a precise volume of fluid sample from a single sample preparation reservoir into two or more test containers storing different reagents, allowing multiplex testing of a single sample.

Embodiments of the present disclosure provide devices, systems, and methods capable of preparing a test sample and subsequently testing the test sample, for example by amplification in conjunction with fluorescent markers. An embodiment includes a diagnostic test assembly (also referred to herein as a “cartridge”) for use with a diagnostic test instrument to perform a diagnostic test on a biological or environmental sample. Such a cartridge may be used with a diagnostic test apparatus (also referred to herein as an “instrument”). As described herein, the cartridge is easy for a user to operate without requiring the facilities of a general test laboratory.

Throughout the following description, various embodiments will be described with reference to an example implementation of a rapid, nucleic acid-based diagnostic system that may test for a variety of diseases. As illustrative examples, the system may test for sexually transmitted infections (STIs), such as gonorrhea and chlamydia, and respiratory tract infections (RTIs), such as influenza A or B. The example system is targeted to the Point of Care (POC) market where case of use, simplicity, CLIA waivability and rapid turnaround time (TAT) of results are considerations. It will be understood, however, that any of the devices, systems, and methods described herein may be applied to any other medical, forensic, or other application.

The present disclosure relates to devices, systems, and method capable of carrying out amplification, such as isothermal amplification, of nucleic acids in a sample. Unless specifically made clear to the contrary, where the term amplification is used herein, any variant of amplification, including but not limited to isothermal amplification and PCR amplification (including real-time and quantitative PCR), is intended to be encompassed. It will be understood that devices, systems, and methods of the present disclosure are not limited to amplification of nucleic acids, and can test a sample for the presence or absence of any target of interest. It will also be understood that devices, systems, and methods of the present disclosure are not limited to processing or preparing a sample before the sample is tested for the presence or absence of a target on interest.

### Example Diagnostic Test Device

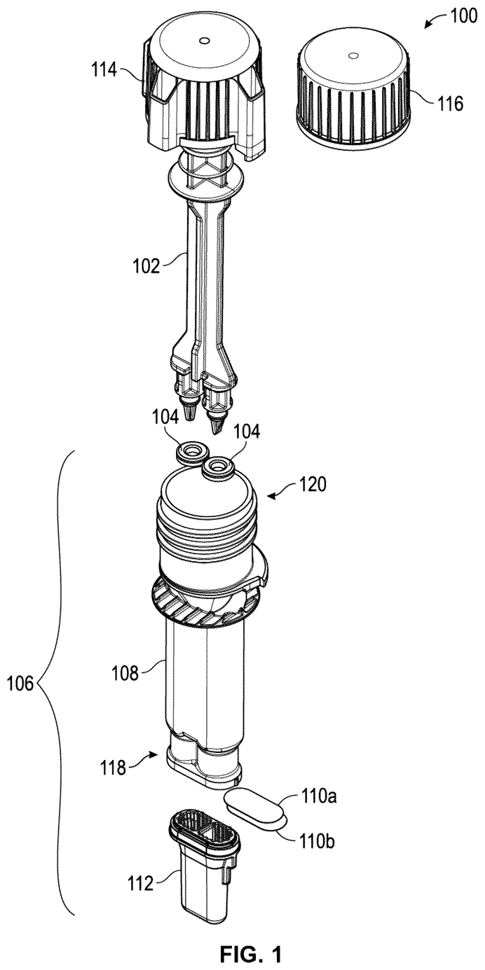

An example diagnostic test device 100 according to the present disclosure is now described with reference to FIGS. 1-7E.

The diagnostic test device 100 is implemented in a rapid, nucleic acid-based test system capable of performing automated molecular diagnostic testing for the detection of a variety of analytes of interest. The diagnostic test device 100 includes a cartridge 106 that is configured to be inserted into a diagnostic instrument of the test system. In one non-limiting example, the cartridge 106 is a consumable plastic container. The cartridge 106 can be formed of an injection-molded plastic, or any other suitable material. The cartridge 106 may include a barcode, for example a barcode displayed on an exterior surface of the cartridge 106, which can be scanned by the diagnostic test apparatus to automatically identify the assay to be performed on a patient sample that is added to the cartridge 106. In this non-limiting example, the assay includes a sample preparation assay and an isothermal amplification assay for the detection of nucleic acids of interest. A user may enter patient and/or sample information via a touchscreen on the instrument or via a barcode scan.

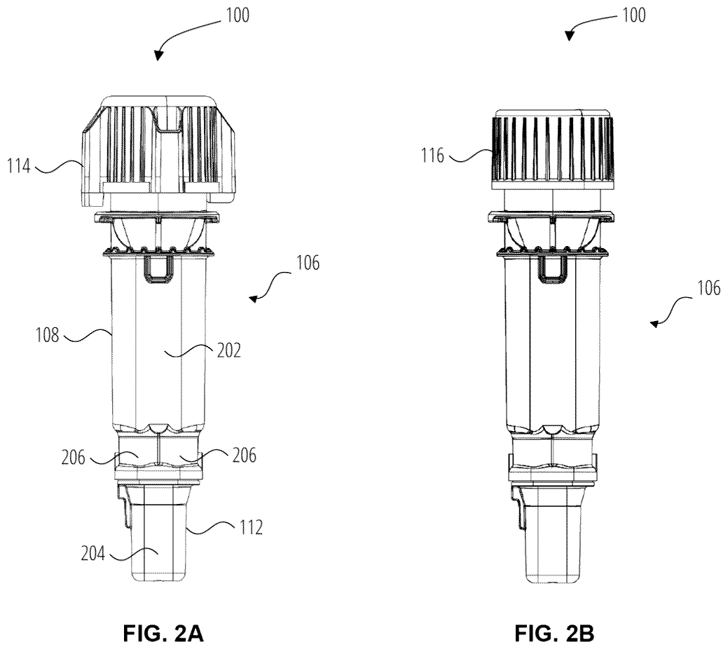

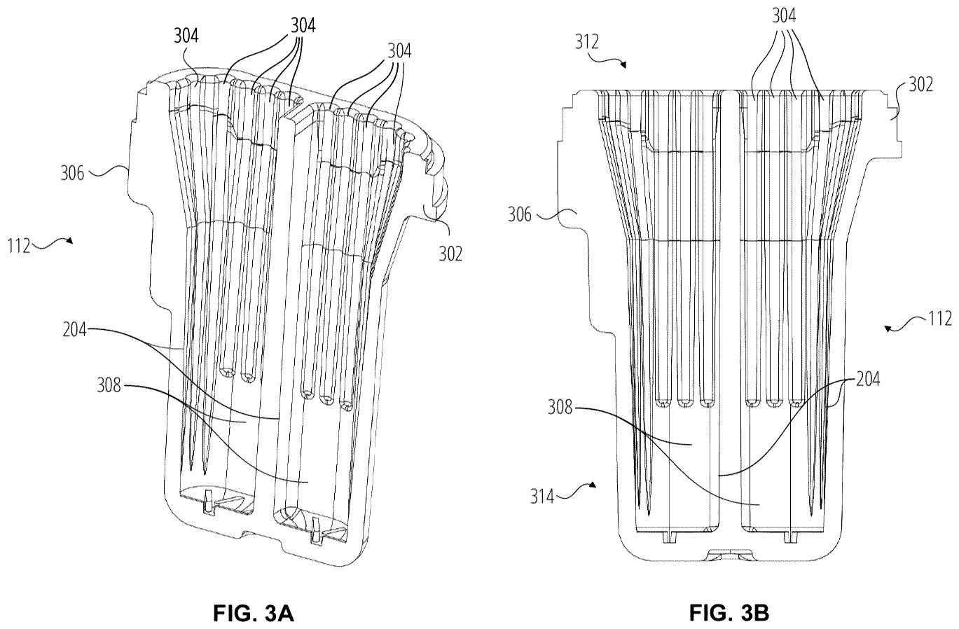

In addition to the cartridge 106, the diagnostic test device 100 includes a dispensing mechanism 102 that is configured to interface with the cartridge 106 as illustrated in FIG. 1. The cartridge 106 may include a cartridge body 108, a test container 112, and one or more seals 110a and 110b. The diagnostic test device 100 may include a closure configured to close a first end 120 of the cartridge body 108. For example, the diagnostic test device can include a dispense cap 114 and/or a transportation cap 116. The dispense cap 114 may be coupled to the dispensing mechanism 102. The dispensing mechanism 102 may include one or more sealing members 104, for example an o-ring, gasket, or a grommet. In the non-limiting embodiment of FIG. 1, the one or more sealing members 104 include two o-rings. As illustrated in FIGS. 2A and 2B, the dispense cap 114 and the transportation cap 116 are each configured to be attached to the first end 120 of the cartridge body 108 to close or seal the first end 120. In one example, the transportation cap 116 is configured to reversibly close or seal the first end 120, and the dispense cap 114 is configured to irreversibly close or seal the first end 120. The cartridge body 108 includes a sample preparation reservoir 202 and one or more cylindrical chambers 206. The cartridge body 108 can form the sample preparation reservoir 108 and the one or more cylindrical chambers 206. Material, such as a fluid, present in the sample preparation reservoir 202 and the one or more cylindrical chambers 206 can be enclosed within the cartridge 108. The test container 112 includes one or more diagnostic test reservoirs 204. The test container 112 can form the one or more diagnostic test reservoirs 204. Material, such as a fluid, present in the one or more diagnostic test reservoirs 204 can be enclosed within the test container 112.

The test container 112 of the cartridge 106 can take any suitable shape and size. In the non-limiting embodiment of FIGS. 1-7, the test container 112 includes one or more tubes, where each tube forms a single diagnostic test reservoir 204. It will be understood, however, that other configurations can be suitably implemented.

Embodiments of the diagnostic test devices, systems, and methods according to the present disclosure can include a test container 112 that minimizes or eliminates sample-containing fluid from being retained on, for example forming droplets on, the walls of the test container 112 where an assay or test reaction does not take place. For example, heat and/or optical signals related to an assay reaction, for example for amplification and detection of nucleic acids, may be directed to the bottom of the diagnostic test reservoir 204 but not to the upper portions of the diagnostic test reservoir 204. Thus, sample-containing fluid present in droplets or fogging in the upper portions of the diagnostic test reservoir 204 may not receive heat as intended. Similarly, sample-containing present in droplets or fogging may not be properly positioned to receive and emit optical signals (or other signals used to detect assay results). Further, ensuring that sample-containing fluid dispensed into the diagnostic test reservoirs 204 is consistently and reliably dispersed to the bottom of the diagnostic teste reservoir 204 may reduce variability of assay results. Consistent and reliable dispersion of sample-containing fluid to the bottom of diagnostic test reservoirs 204 may also ensure a higher likelihood that sufficient sample material, for example genomic material, is available to the assay reaction to ensure an accurate test result. Embodiments of the diagnostic test devices, systems, and methods disclosed herein can thus advantageously increase an amount of sample available to an assay reaction, which in one example embodiment occurs within a volume of fluid that is received and/or collected at the bottom of the test container 112. Embodiments of the diagnostic test device, systems, and methods disclosed herein can, by reducing the formation of droplets on the walls or inner surfaces of the test container 112, prevent and/or reduce the likelihood that a droplet of fluid adheres to the wall or inner surfaces of the test container 112 before a reaction and subsequently falls to the bottom of the reaction chamber while the reaction is ongoing.

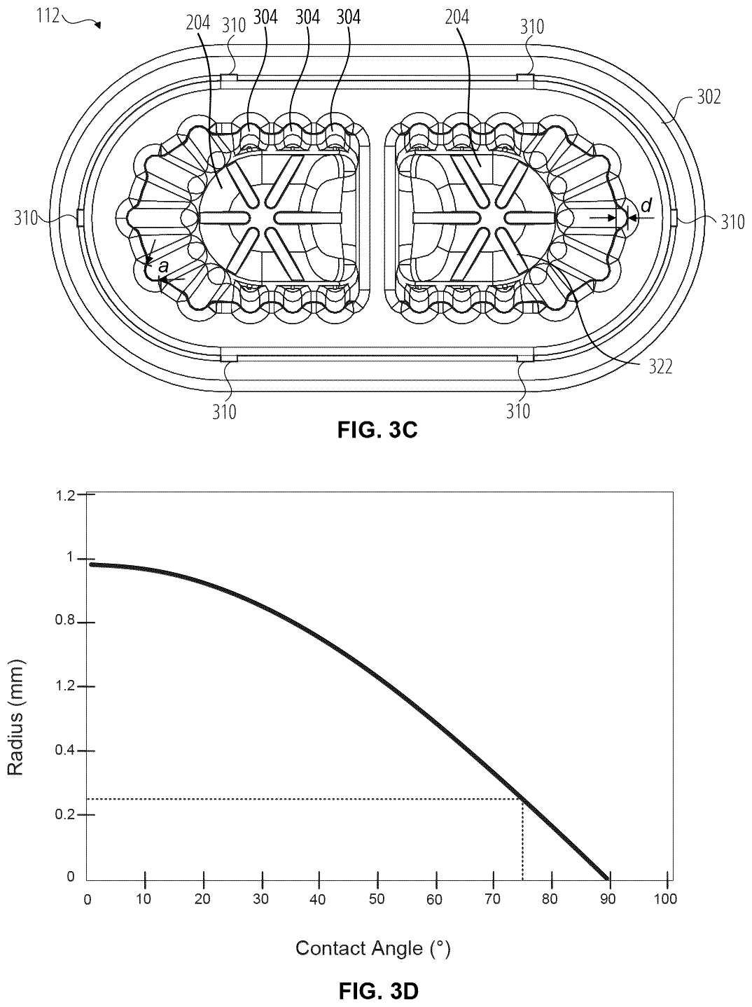

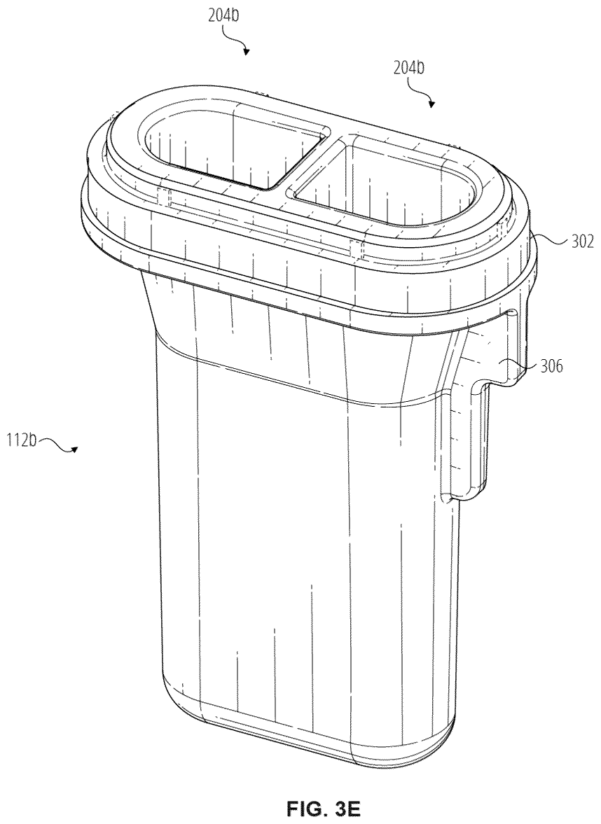

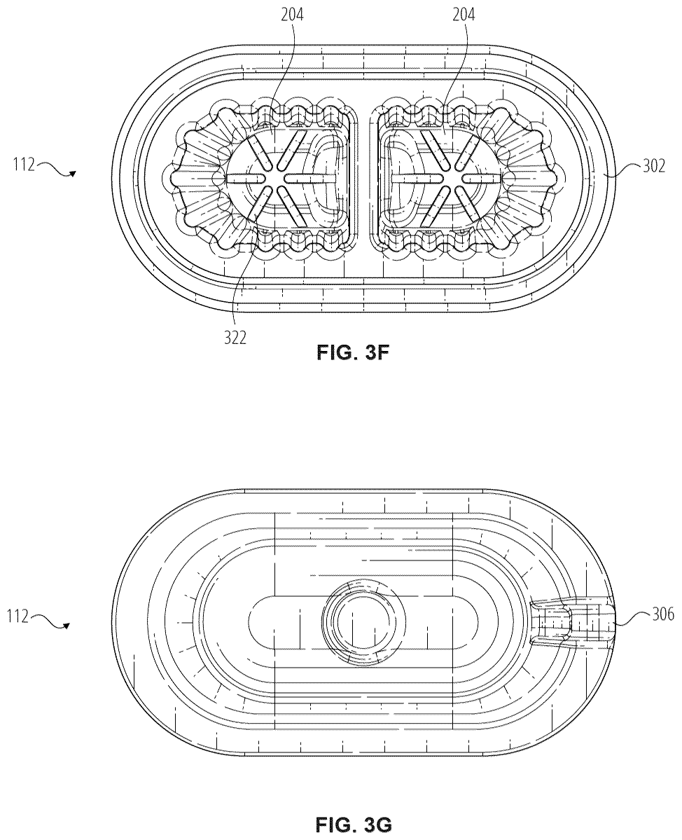

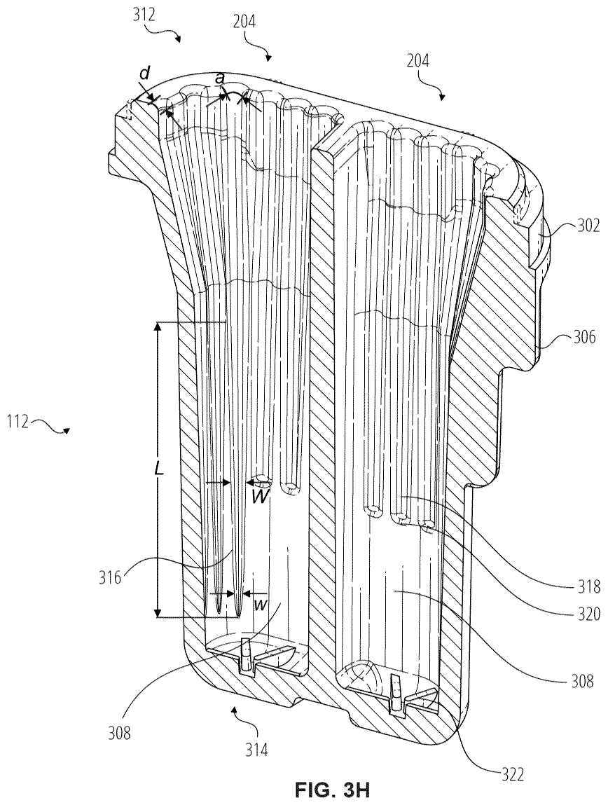

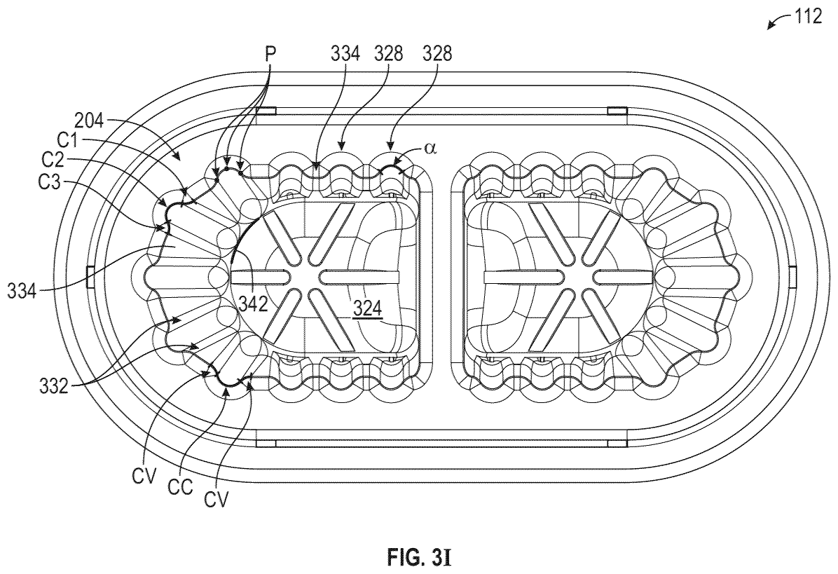

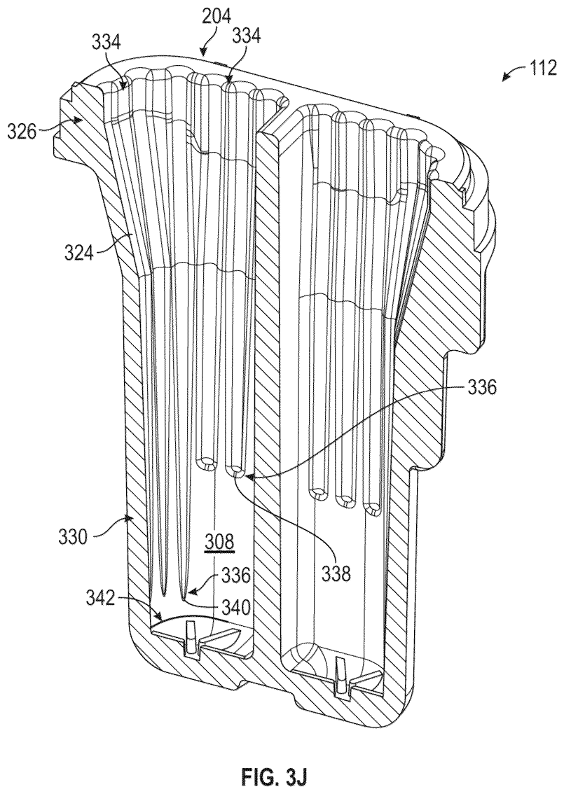

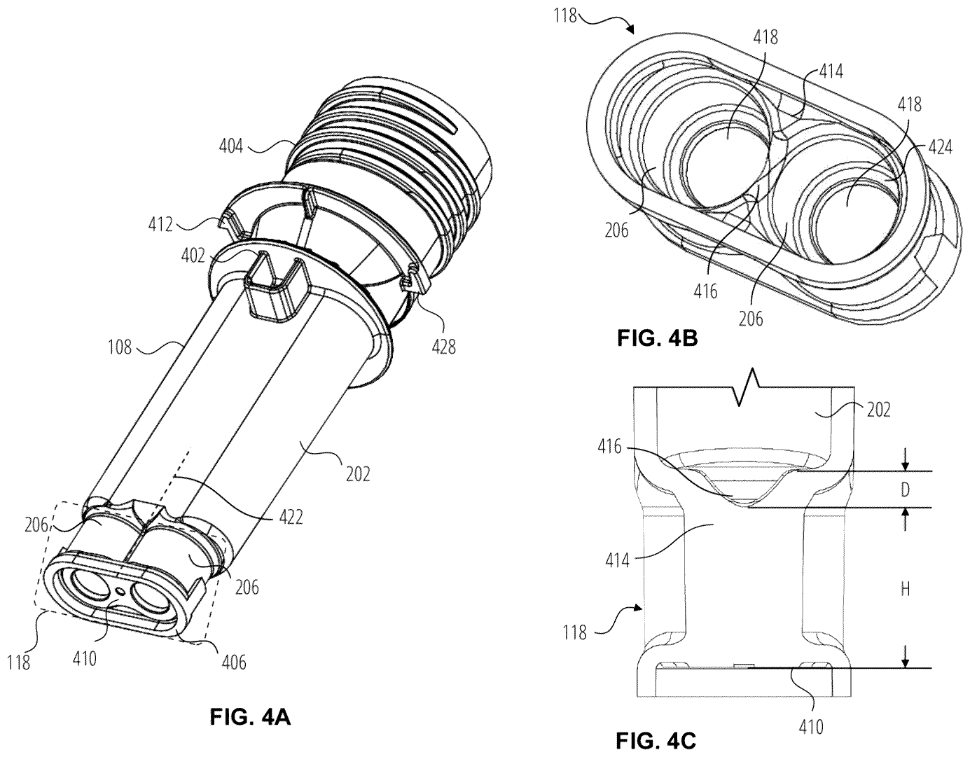

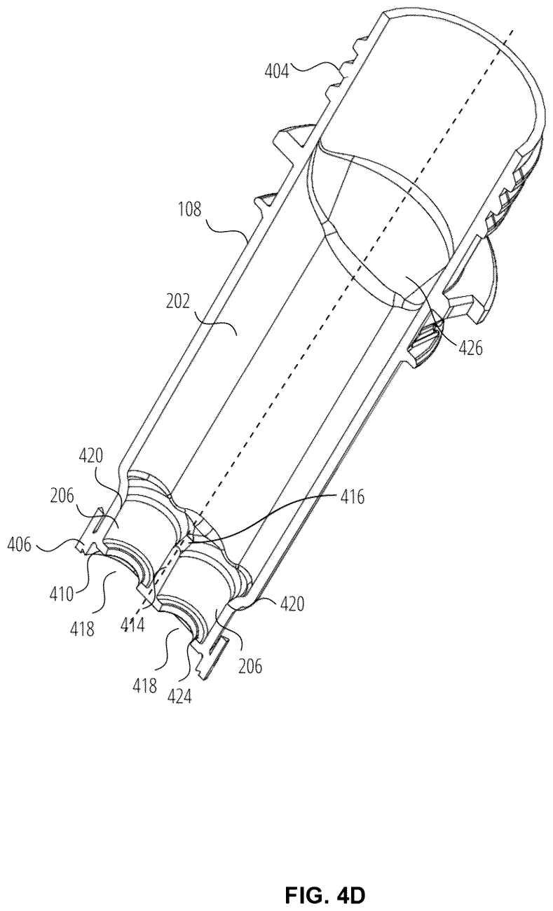

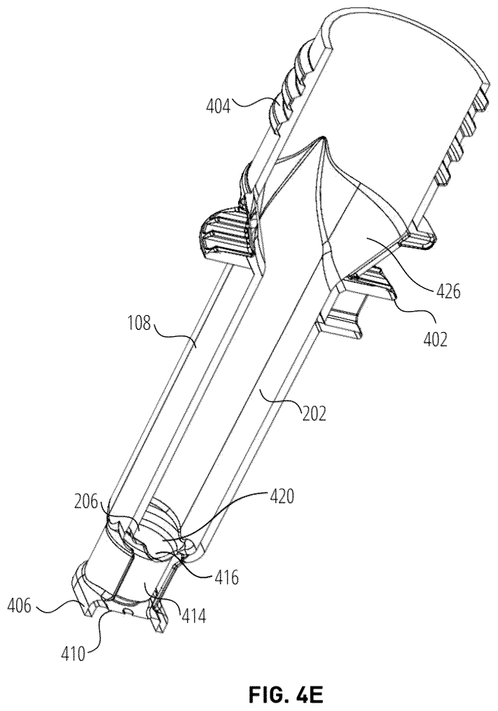

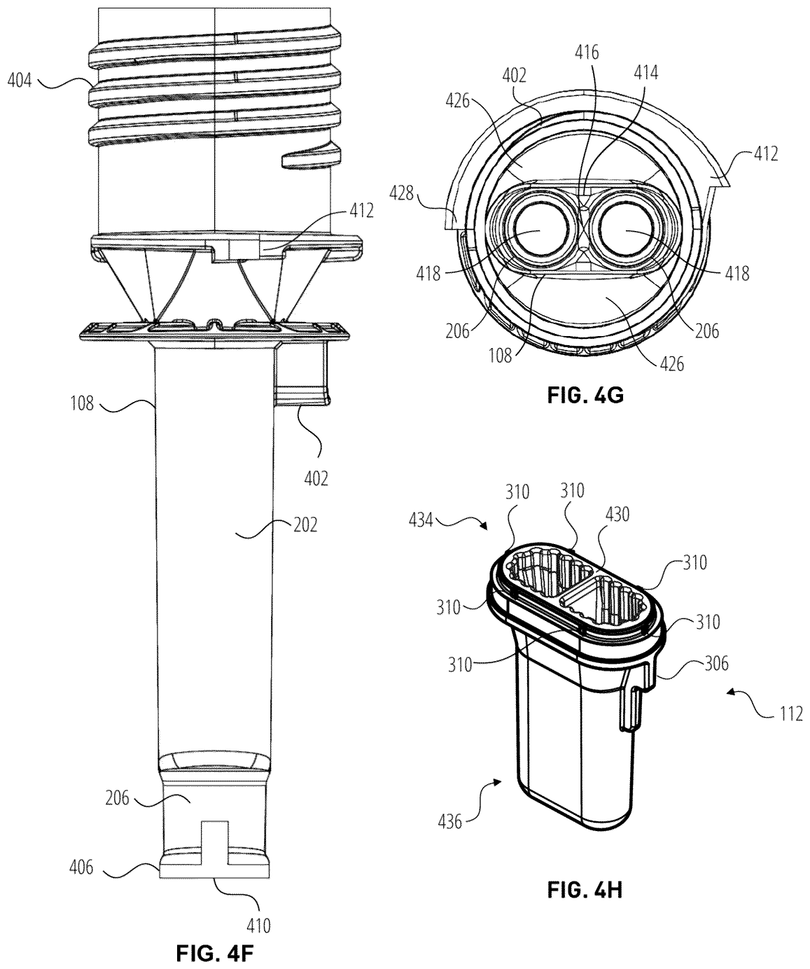

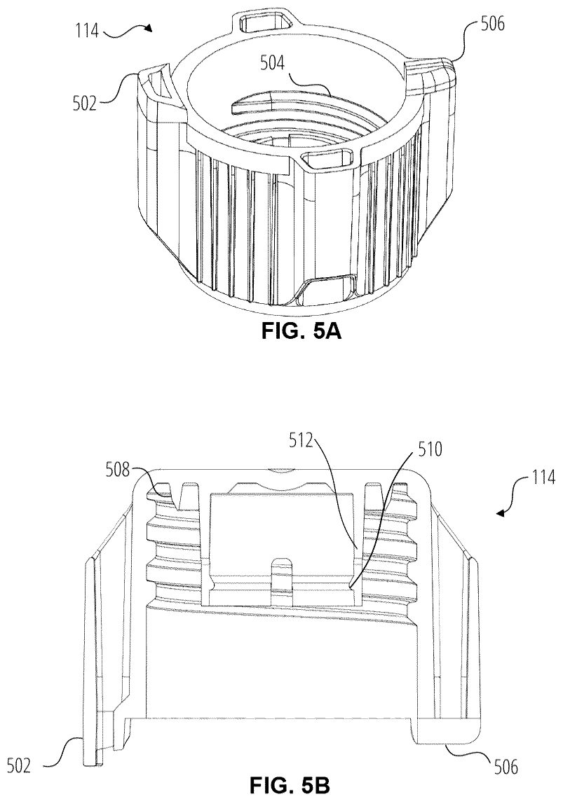

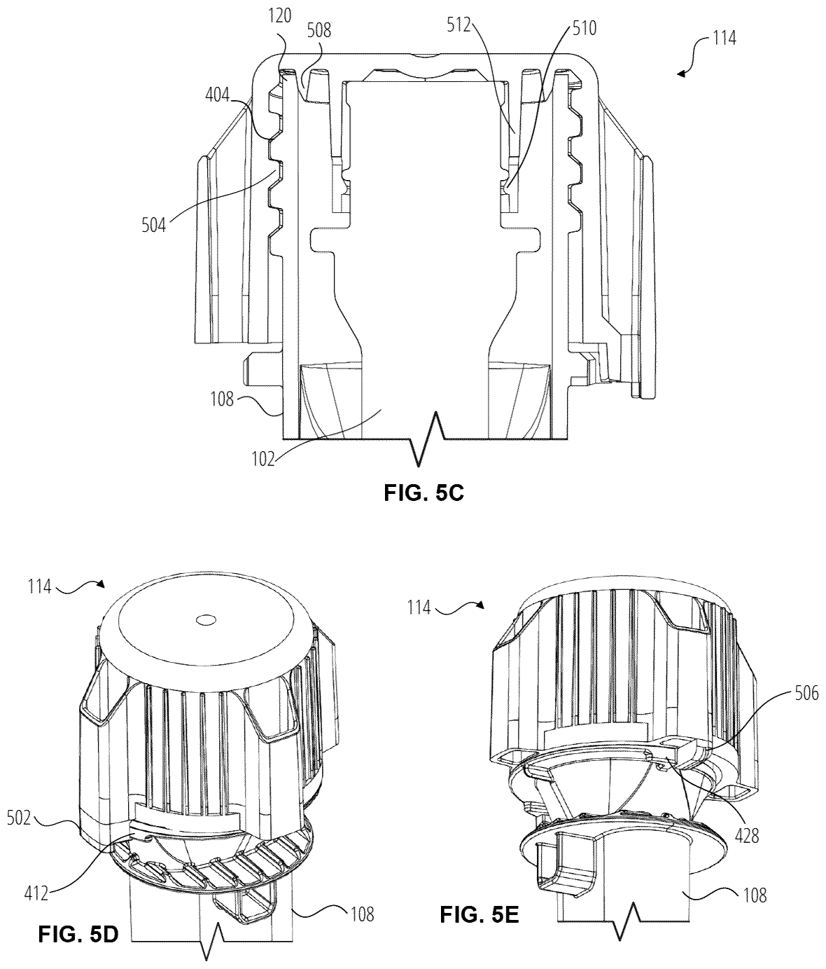

FIGS. 3A, 3B, and 3H illustrate a cross-section of the test container 112. FIG. 3F is a top-down view of the test container 112. FIG. 3G is a bottom-up view of the test container 112. FIG. 4H also illustrates a view of the test container 112. An end 312 of the test container 112 is open, and is configured to receive fluid, allowing passage into the one or more diagnostic test reservoirs 204. Another end 314 of the test container 112 is a closed end. The end 314 can be a bottom, closed end of the one or more diagnostic test reservoirs 204. The end 314 is configured to collect fluid.

Amplification of an analyte of interest may occur within the diagnostic test reservoir 204 of the test container 112. The cartridge body 108 may be coupled to the diagnostic test reservoir 204, where isothermal amplification and fluorescence detection may take place. When attached to the cartridge body 106 with seals 110a and/or 110b, the one or more diagnostic test reservoirs 204 are physically and fluidically separate from each other. A second end 118 opposite the first end 120 of the cartridge body 108 may be coupled to an end 312 of the test container 112. Other configurations can be suitably implemented. For example, in another non-limiting embodiment, the cartridge body 108 and the test container 112 are integrated in a unitary structure. Amplification, such as but not limited to isothermal amplification, and detection, such as but not limited to fluorescence detection, of one or more analytes of interest may take place in the one or more diagnostic test reservoirs 204. Optical signals can be directed to the one or more diagnostic test reservoirs 204, and optical signals emitted from the one or more diagnostic test reservoirs 204 can be detected and correlated to the presence, absence, and, in some cases, quantity of the one or more analytes of interest may be directed to the one or more diagnostic test reservoirs 204. The walls of the test container 112 may include a plastic, for example a polycarbonate and/or a polypropylene or any other suitable material (such as, but not limited to, polyethylene). It may be desirable to choose a material that is transparent, substantially transparent, and/or not opaque to facilitate the transmission of optical signals through the walls of the test container 112. The test container 112 may also include a lip 302 to facilitate attachment of the test container 112 to the cartridge body 108 as disclosed herein. The test container 112 may include one or more projections 310 situated on or around the lip 302.

It is to be understood that the present disclosure is not limited to test containers 112 having two diagnostic test reservoirs 204 as depicted in FIGS. 1, 3A-3C, 3E-3H, and 4H. For instance, a test container 112 can be implemented with one diagnostic test reservoir 204. Alternatively, a test container 112 can be implemented with three, four, or more diagnostic test reservoirs 204.

The test container 112 may include one or more capillary grooves 304. The capillary grooves 304 may facilitate flow of dispensed liquid from the sample preparation reservoir 202 toward the bottom of the diagnostic test reservoir 204. In one example, a chamber 324 of the diagnostic test reservoir 204 is configured to receive a fluid from the sample preparation reservoir at a first section 326 of the chamber 324. The capillary grooves 304 are configured to promote flow of the fluid toward a second section 330 of the chamber 324. Each capillary groove 304 may be an indentation that extends down at least a portion of the height of the inner surface of the diagnostic test reservoir 204. In some embodiments, no part of the capillary grooves project into the inner space of the test container 112. Because each capillary groove 304 may be an indentation in the inner wall of the diagnostic test reservoir 204, a test container 112 having one or more capillary grooves 304 may have a have a larger internal volume than a test container 112 without capillary grooves. FIG. 3E depicts an embodiment of a test container 112b having diagnostic test reservoirs 204b that do not include capillary grooves.

When viewed from above, as shown in FIG. 3C, the cross-section of each capillary groove 304 may be semicircular and/or semielliptical. It will be understood that capillary grooves 304 having other cross-sectional profiles can be suitably implemented in embodiments of the present disclosure. As illustrated in FIGS. 3A-3B and 3H, some of the capillary grooves 304 may terminate substantially above the end 314 of the test container 112, and above window regions 308. The one or more window regions 308 have walls that are substantially planar and/or flat, with no, substantially no, or minimal optical interference due to the geometry of the test container 112 wall. The one or more window regions 308 do not include any capillary grooves 304. The optical detection of an analyte of interest may involve transmission of excitation signal and/or detection signal through the one or more window regions 308. In some embodiments, the blunt ends of one or more blunt-ended capillary grooves 318 may define the top of the one or more window regions 308. The window regions are located proximate to the end 314 of the test container 112, and spaced away from the end 312 of the test container 112. In another embodiment, none of the capillary grooves 304 extend to the end 314 of the test container 112. In still another embodiment, all of the capillary grooves 304 extend to the end 314 of the test container 112.

It may be advantageous that some of the capillary grooves 304 extend to the end 314, or proximate to the end 314, to facilitate fluid flow down the entire height of the diagnostic test reservoir 204. In some embodiments, the total length of a capillary groove 304 (for example, the total distance the capillary groove 304 extends from the end 312 towards the end 314) may depend in part on the total volume of liquid dispensed to the diagnostic test reservoir 204. In facilitating flow of fluid droplets toward the end 314, it may be desirable that capillary grooves 304 are able to convey these fluid droplets to at least the top surface of fluid already located at the end 314. Accordingly, as an illustrative example, if the volume of liquid dispensed to the diagnostic test reservoir 204 is substantially greater than half of the total volume of the diagnostic test reservoir 204, the capillary grooves 304 need not run below about half the height of the diagnostic test reservoir 204, because the top surface of the dispensed liquid would be above a lower terminal end of the capillary grooves 304. In the embodiments depicted in FIGS. 3A-3B and 3H, if 100 μl of fluid dispersed to each of the diagnostic test reservoirs 204, the top surface of that fluid would be higher than the top of the window regions 308. Thus, even the shorter blunt-ended capillary grooves 318 would extend through the top surface of the fluid. In some embodiments, one or more of the capillary grooves, for example tapered capillary groove 316, may taper as it approaches the end 314 end of the test container. In some embodiments, one or more of the capillary grooves, for example blunt-ended capillary 318, does not taper but instead has a rounded, blunt end 320 as it approaches end 314. In some embodiments, at least one of the capillary grooves is a tapered capillary groove 316 and at least one of the capillary grooves is a blunt-ended capillary groove 318. In one non-limiting example, near the end 312 of the test container 112, the width of a blunt-ended capillary groove 318 may be approximately 0.5 mm. Up to about the blunt end, the width of a blunt-ended capillary groove may continue to be approximately 0.5 mm (for example, not tapering). The blunt-ended capillary grooves 318 may run approximately 14 mm from the top of the diagnostic test reservoir 204 to the top of the window region 308. In embodiments where the test container 112 is manufactured by injection molding, it may be desirable to taper the capillary grooves 304 to allow or to assist the test container 112 to be pulled off a core of an injection mold.

In some embodiments, a “tapered” capillary groove diminishes and/or reduces in width as the capillary groove approaches the end 314. For example, as indicated by the arrows about tapered capillary groove 316, the width of the capillary groove 316 is smaller close to the end 314 of the test container 112. For instance, a width W of tapered capillary groove 316 is larger than a width w of capillary groove 316 at a height closer to the end 314. In one non-limiting example, the width of the tapered capillary groove 316 may be approximately 0.5 mm near the end 312 of the test container 112. In some embodiments, the width W may be approximately 0.3 mm, and width w may be smaller still. The depth d of the tapered capillary groove 316 may also reduce as the tapered capillary groove 314 approaches the end 314. For example, near the end 312 of the test container 112, the depth d of the tapered capillary groove may be approximately 0.25 mm, corresponding to a capillary arc length a of approximately 0.64 mm. In some embodiments, the tapered capillary groove 316 does not taper along the entire length but begins tapering at a height below the end 312. The tapered capillary groove 316 can include a taper across a distance L. In some embodiments, the tapered capillary grooves 316 may begin tapering above the blunt end of the blunt-ended capillary grooves 318. In some embodiments, the tapered capillary grooves 316 begin tapering at approximately the height of the blunt end of the blunt-ended capillary grooves 318. In some embodiments, the tapered capillary grooves 316 may extend closer to the end 314 of the test container 112 than the blunt-ended capillary grooves 318. The capered capillary grooves 316 may continue to end 314 of the test reservoir 204 or may terminate above the end 314 of the test reservoir 204.

Embodiments of capillary grooves according to the present disclosure can be shaped and sized to optimize flow of a liquid from a first reservoir, such as the sample preparation reservoir 202, to a second reservoir, such as the diagnostic test reservoir 204. For example, capillary grooves according to the present disclosure can be dimensioned to optimize flow of a liquid by capillary action, or capillarity. The optimal dimensions of a capillary configured to promote flow of a liquid depends in part on properties of the liquid itself. Equation 1 describes the relation of various parameters with respect to fluid droplet flow on a capillary groove:

$$h = \frac{2 T cos ( θ )}{pgr} . \qquad 1$$

where h is elevation of the liquid, Tis surface tension of the fluid, θ is the angle of contact of the liquid with the capillary groove in radians, p is the density of the liquid, g is the standard acceleration due to gravity (9.8 m/s²), and r is the radius of the capillary groove. The relationship between angle of contact of the liquid θ (in degrees) and radius of the capillary groove r, while other variables are held constant, is plotted in FIG. 3D. For FIG. 3D, the height h was set to 15 mm, which is approximately the length between the end 312 of the test container 112 to the window region 308. For FIG. 3D, surface tension T was assumed to be that of water at room temperature (0.072 dyne/m) and density p was assumed to be that of water at room temperature (997.77 kg/m³). Assuming a particular height h and a fluid having properties similar to water at room temperature, the radius r and/or contact angle θ can be selected for a particular application. In other words, optimal capillary groove parameters can be advantageously selected for a specific use case. For example, if a contact angle of θₐ is optimal for a particular application, capillary grooves having a radius of rₐ can be selected. In some embodiments of the test container 112 having a capillary groove of height 15 mm and assuming a fluid having properties similar to water at room temperature, the capillary groove radius is 0.25 mm and corresponds to an angle of contact of the liquid θ of approximately 76°. FIG. 3D indicates a capillary groove radius of 0.25 mm and contact angle of 76° with dashed lines. A capillary groove radius of 0.25 mm may be desirable for use with room temperature water because it is not so small that it is difficult to manufacture, while yielding a relatively high contact angle. A high contact angle may better promote capillary action on droplets than a low contact angle. The above-discussed parameters, for example radius r of the capillary groove, can be optimized to facilitate flow of other liquids having different properties, for example different viscosity, surface tension, and/or different density, than water. Further, the number of capillary grooves included may be chosen to optimize fluid flow toward the end 314 of the diagnostic test reservoirs 204. Generally, inclusion of additional capillaries may further promote fluid flow toward the end 314, while reduction in the number of capillaries may reduce fluid flow toward the end 314 and/or preserve areas of the walls of the test container 112 for transmission of signals, such as optical signals.

The test container 112 may include a detection tab 306. The detection tab 306 may facilitate detection of the presence or the absence of the test container 112 received within the diagnostic test apparatus. For example, the diagnostic test apparatus can include a sensor, such as a mechanical sensor, configured to interact with the detection tab 306 of the test container 112. Insertion of the test container 112 into the diagnostic test apparatus can cause the detection tab 306 to press the mechanical sensor of the diagnostic test apparatus, indicating that the test container 112 is properly seated within the diagnostic test apparatus. Other configurations can be suitably implemented. For example, the diagnostic test apparatus may include an optical sensor that emits an optical signal that is interrupted by the detection tab 306 when the test container 112 is properly seated. The detection tab 306 may include a “stepped” shape as illustrated in FIG. 4H. The test container 112 may also include a lip 430 to facilitate attachment of the test container 112 to the cartridge body 108 as described in greater detail below.

The one or more diagnostic test reservoirs 204 can be pre-loaded with reaction components to run a specific diagnostic test. For example, the one or more diagnostic test reservoirs 204 may contain lyophilized reagents. The lyophilized reagents may include enzymes, primers, probes, beacons, salts, and/or other reagents used in assay reactions. Mixing beads may also be included within the one or more diagnostic test reservoirs 204. The beads can be magnetic beads. The beads may be embedded inside a pellet of lyophilized reagents. When a fluid sample is introduced into the one or more diagnostic test reservoirs 204 and rehydrates the lyophilized reagents, the beads may facilitate mixing of the lyophilized reagents with the fluid sample. For example, the beads may be moved within the one or more diagnostic test reservoirs 204 under the influence of a magnetic force, to cause motion within any liquid within the one or more diagnostic test reservoirs 204 and aid in dissolving the lyophilized reagents. The bead may include stainless steel or any other suitable material. In alternative embodiments, the one or more diagnostic test reservoirs 204 can be pre-loaded with liquid reagents. In such embodiments, it may still be desirable to mix the preloaded liquid reagents with fluid sample, for example by agitating magnetic beads included within the one or more diagnostic test reservoirs 204. In some embodiments, the one or more diagnostic test reservoirs 204 may contain one or more fins 322. The fins 322 can provide surfaces for the lyophilized reagents to grip, thereby promoting adhesion of the lyophilized reagents to the bottom of the diagnostic test reservoirs 204.

A non-limiting example of capillary grooves according to the present disclosure will now be described with reference to FIGS. 31 and 3H, which illustrate a top view and a cross-section of the test container 112 of a diagnostic test device. Features described above with reference to FIGS. 3A-3C, 3F-3H, and 4H can be implemented in this non-limiting example. The diagnostic test reservoir 204 includes a chamber 324 configured to receive a fluid from a sample preparation reservoir at a first section 326 of the chamber 324. In this example, the capillary grooves include a plurality of spaced apart valleys 328 along an inner surface of the chamber 324. The plurality of spaced apart valleys 328 are configured to promote flow of the fluid toward a second section 330 of the chamber 324. The plurality of spaced apart valleys 328 can be configured to inhibit droplets of the fluid from adhering to the inner surface in the first section 326 of the chamber 324 when the fluid is dispensed into chamber 324 from a sample preparation reservoir. The plurality of spaced apart valleys 328 can be configured to increase a volume of the fluid that is collected in the second section 330 of the chamber 324.

Each of the spaced apart valleys 328 includes a curved cross-section. The curved cross-section can include a smooth arc a. A valley of the plurality of spaced apart valleys 328 can include three inflection points P. A valley of the plurality of spaced apart valleys 328 can include three curvatures C1, C2, and C3. A valley of the plurality of spaced apart valleys 328 can include two convex portions CV separated by a concave portion CC. Transitions between the inner surface of the chamber 324 and the plurality of spaced apart valleys 328 can include rounded edges 332. A valley of the plurality of spaced apart valleys 328 can include a semicircular or semielliptical cross-sectional shape. The plurality of spaced apart valleys 328 can be separated by a planar portion 334 of the inner surface of the chamber 324.

A portion of the inner surface in the second section 330 of the chamber 324 can form a continuous circumferential surface. A portion of the inner surface in the second section 330 of the chamber 324 can form a continuously curved surface. The inner surface can form a closed perimeter in the chamber 324. A portion of the inner surface can terminate in a smooth arc 342 in the second section 330 of the chamber 324. A portion of the inner surface can be continuous between the first section 326 of the chamber 324 and the smooth arc in the second section 330 of the chamber 324.

The chamber 324 can include a window region 308 below ends of the plurality of spaced apart valleys 328. The window region 308 does not include a valley of the plurality of spaced apart valleys 328.

A valley of the plurality of spaced apart valleys 328 can be tapered along a portion of its height. The valley can begin tapering at a height between the first section 326 and the second section 330. An end 336 of a valley of the plurality of spaced apart valleys 328 can have a semicircular profile 338. An end 336 of a valley of the plurality of spaced apart valleys 328 can have a tapered profile 340. A first valley of the plurality of spaced apart valleys 328 can extend a first distance toward the second section 330 of the chamber 324 and a second valley of the plurality of spaced apart valleys 328 can extend a second distance toward the second section 330 of the chamber 324, where the second distance is longer than the first distance. A valley of the plurality of spaced apart valleys 328 can have a different cross-sectional shape in the first section 326 of the chamber 324 than the cross-sectional shape at an end of the valley.

FIGS. 4A-4G illustrate aspects of the cartridge body 108 according to the present disclosure. As shown in the cross-sectional view of FIG. 4D, the cartridge body 108 includes the sample preparation reservoir 202 and the one or more cylindrical chambers 206. The cartridge body 108 can also include a key 402, a threaded wall 404 at the first end 120, a lip 406 at the second end 118, a locking thread 412, and a blocking flange 428. An end 410 of the one or more cylindrical chambers 206 are also illustrated in FIGS. 4A and 4D. The cartridge body 108 can also include a lower surface 424 of the cylindrical chamber 206. The sample preparation reservoir 202 can be pre-loaded with reaction components to run a specific diagnostic test. For example, the sample preparation reservoir 202 may be pre-loaded with a volume of sample preparation fluid. A sample may be carried on a swab, which can be inserted into the sample preparation reservoir 202. The sample preparation reservoir 202 may contain a sample preparation fluid to wash the sample from the swab into the sample preparation fluid, thereby creating a fluid sample within the sample preparation reservoir 202. The fluid sample in the sample preparation reservoir 202 may be configured to undergo processing to collect and/or concentrate nucleic acids, such as DNA and/or RNA. In some embodiments, the sample preparation fluid may include an ELB. As illustrative examples, ELB may include red blood cell lysis buffer (RBCC), glycine running buffer solution (GRBS), and/or sodium dodecylsulfate solution (SDS). In alternative embodiments, the sample preparation fluid need not be pre-loaded into the sample preparation reservoir 202, but may be loaded shortly before the sample is introduced.

FIG. 4B shows a top-down cross-sectional view of the second end 118, indicated by the dotted rectangle in FIG. 4A, of the cartridge body 108. FIG. 4C shows a side cross-sectional view from dotted line 422 shown in FIG. 4A.

The sample preparation reservoir 202 may have a fluidic volume many times larger than the one or more diagnostic test reservoirs 204. As an illustrative example, the sample preparation reservoir 202 may have a volume of about 6 mL while the one or more diagnostic test reservoirs 204 may contain a combined total fluidic volume of about 400 μL. In some examples, the sample preparation reservoir 202 may hold a fluidic volume of between 0 and 5 mL, between 0.5 and 4.5 mL, between 1 and 4.0 mL, between 1.5 and 3.5 mL, between 2 and 3 mL, or any value or range within or bounded by any of these ranges or values, although values outside these values or ranges can be used in some cases. Additionally or alternatively, in some examples the sample preparation reservoir 202 may hold between 1 and 3 mL of fluidic volume. The amount of sample preparation fluid actually held by the sample preparation reservoir 202 may depend on the particular assay.

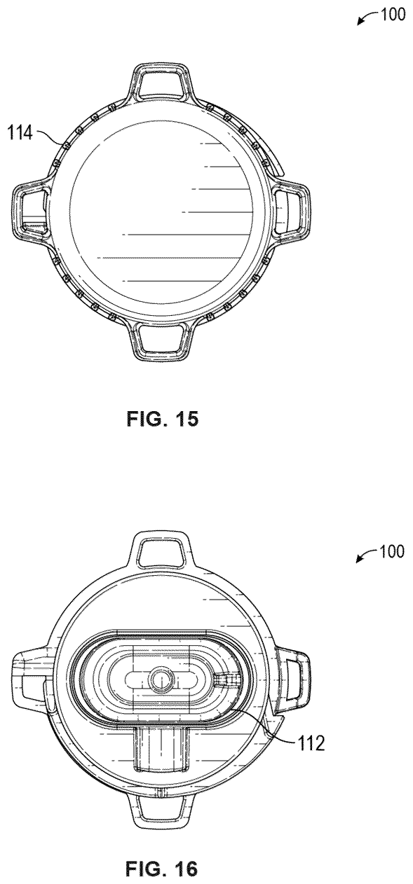

The one or more diagnostic test reservoirs 204 are configured to receive a predetermined volume of fluid sample from the sample preparation reservoir 202 through a process according to the present disclosure, including but not limited to the example process described below with reference to FIG. 8. The one or more diagnostic test reservoirs 204 may hold a fluidic volume of up to 50 μL of liquid, up to 75 μL of liquid, up to 100 μL of liquid, up to 150 μL of liquid, up to 200 μL of liquid, up to 250 μL of liquid, up to 300 μL of liquid, up to 350 μL of liquid, up to 400 μL of liquid, up to 450 μL of liquid, up to 500 μL of liquid, up to 1000 μL of liquid, or any value or range within or bounded by any of these ranges or values, although values outside these values or ranges can be used in some cases. Additionally or alternatively, in some examples the one or more diagnostic test reservoirs 204 may hold 200 μL of fluidic volume.

In some examples, the cartridge body 108 may include a geometry to facilitate rapid heating of the contents of the sample preparation reservoir 202. For example, the cartridge body 108 may have a relatively high surface area-to-volume ratio, which may facilitate rapid heating, for example by having an oblong cross-section. The walls of the cartridge body 108 may include a polypropylene material or any other suitable material (such as, but not limited to, polyethylene). In the embodiment depicted in FIGS. 4A-4G, the cartridge body 108 transitions from having a circular lateral cross-section near first end 120 to having an oblong lateral cross-section lower within the cartridge body 108. Depicted in FIGS. 4D, 4E, and 4G, a sloped wall 426 of the cartridge body 108 is the feature that transitions from a circular lateral cross-section to an oblong lateral cross-section. At the portion of the sloped wall 246 closest to first end 120, the lateral cross-section is relatively circular, becoming relatively oblong with proximity to the cylindrical chambers 206.

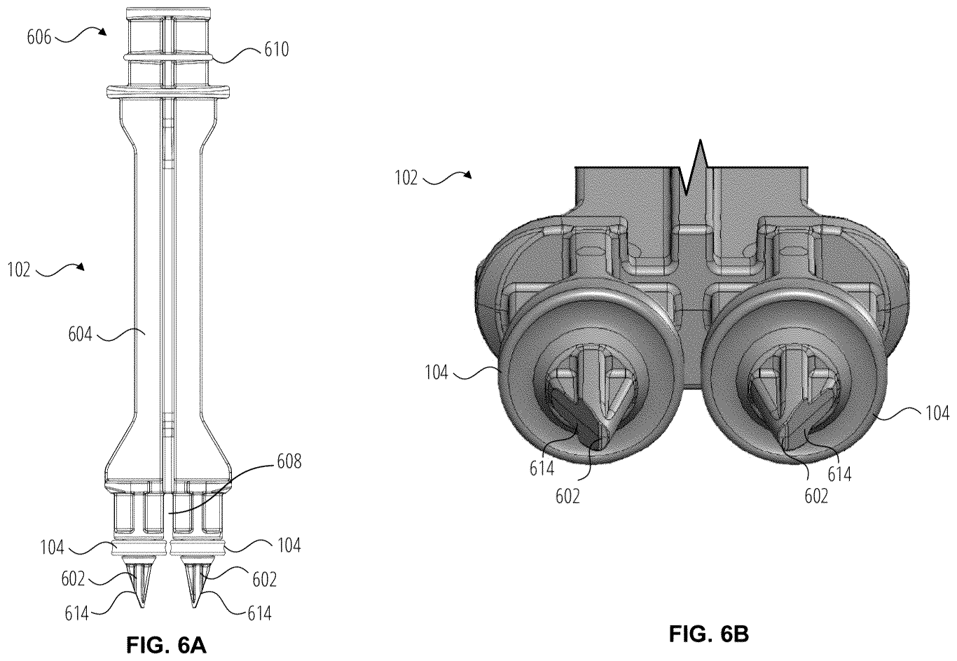

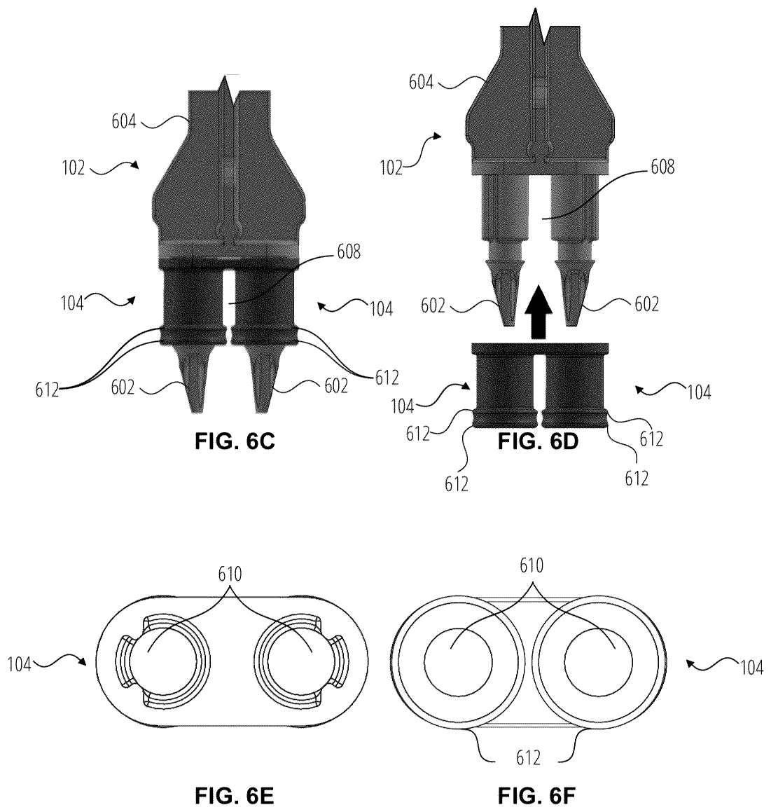

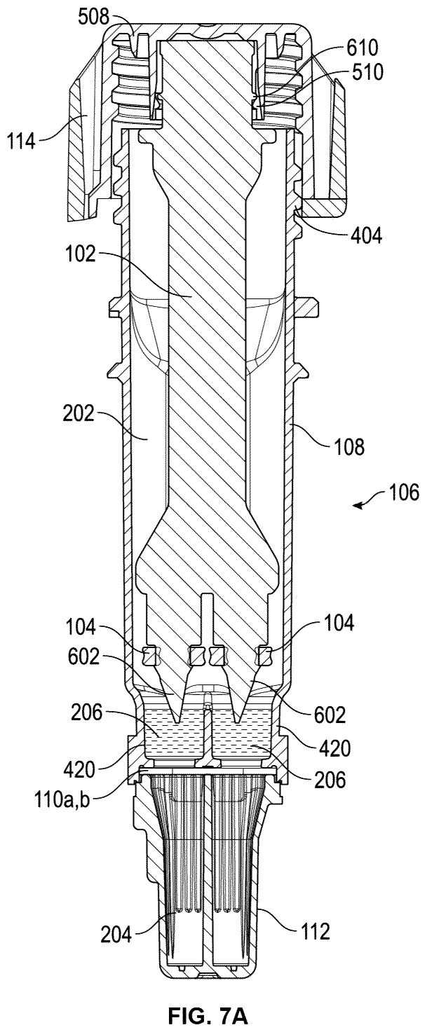

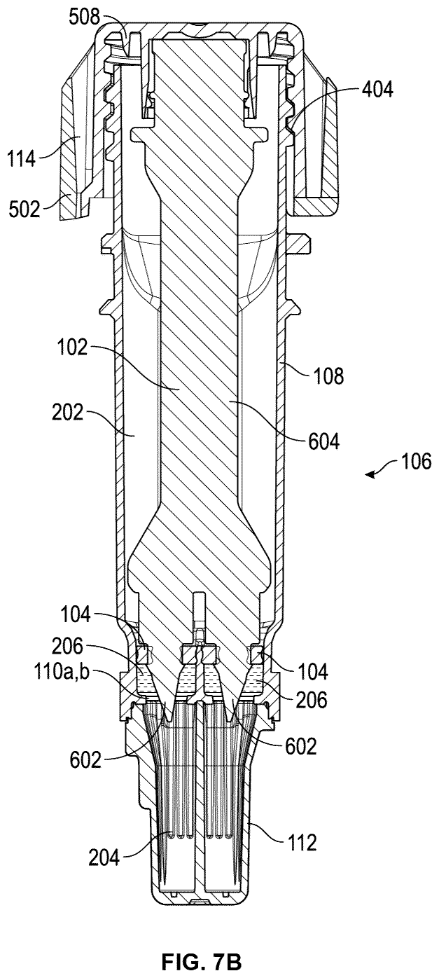

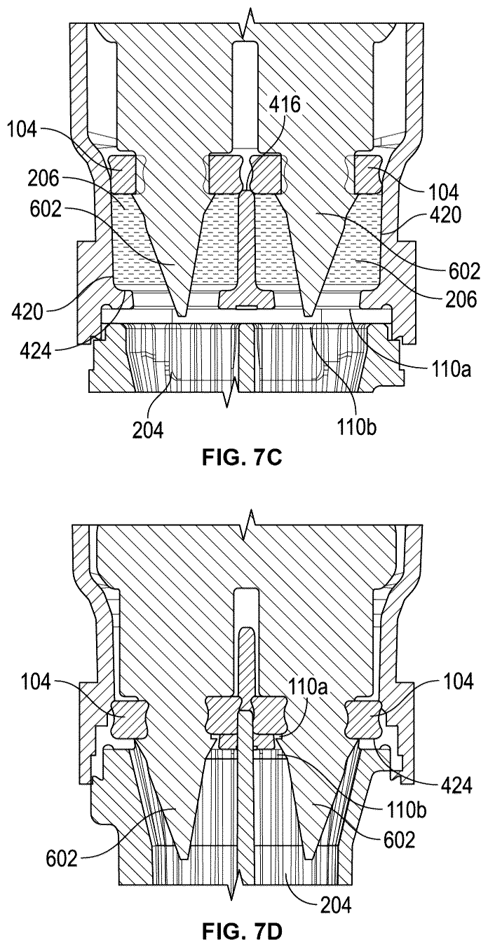

With reference now to FIGS. 5A and 5B, the dispense cap 114 includes a locking tab 502, internal threads 504, an overtravel tab 506, a plug seal 508, and an internal ring 510 projecting from a flange 512. The internal ring 510 in this non-limiting embodiment is a raised annular portion that projects from an internal surface of the flange 512. The flange 512 is configured to surround at least a portion of an end 606 of the dispensing mechanism 102 when the dispensing mechanism 102 is coupled to the dispense cap 114. The internal ring 510 engages a corresponding ring 610 at the end 606 of the dispensing mechanism 102 in a way that allows the dispense cap 114 to rotate freely about the dispense mechanism 102 when it is coupled to the end 606 of the dispense mechanism 102. In embodiments of the present disclosure, the dispense cap 114 rotates about a longitudinal axis of the dispensing mechanism 102 even though the dispense mechanism 102 remains stationary after insertion into the cartridge body 108, as described in greater below.

In this non-limiting example, the internal ring 510 and the ring 610 are reversibly coupled with a flexible interference fit, allowing the ring 610 to be reversibly snapped into and snapped out of the internal ring 510. It will be understood that other mechanisms to couple the dispense cap 114 to the dispense mechanism 102 can be suitably implemented.

The threaded wall 404 at the first end 120 of the cartridge body 108 may be engaged by a cap, for example the dispense cap 114 or the transportation cap 116. In embodiments of the cartridge body 108 which include the locking thread 412, the locking thread 412 may be also engaged by a cap, for example the dispense cap 114. Twisting a locking tab 502 of the dispense cap 114 in a first direction (in this example, a clockwise direction) past the locking thread 412 causes the dispense cap 114 to lock to the first end 120 of the cartridge body 108, thereby inhibiting and/or preventing motion of the dispense cap 114 in a second direction opposite the first direction (in this example, the counterclockwise direction). FIG. 5D shows the locking tab 502 in the locked position, positioned against the locking thread 412. In the locked position, the dispense cap 114 irreversibly engages the locking thread 412, such that a user cannot unthread the dispense cap 114 and uncouple the dispense cap 114 from the cartridge body 108. Advantageously, embodiments of the cartridge body 108 that include the locking thread 412 can completely seal the fluid sample inside the device 100 once the dispense cap 114 is engaged to the locking thread 412. This can prevent inadvertent contamination or leaking of the fluid sample 100 from the device 100 during or after a diagnostic test is performed.

As depicted in FIG. 5E, the blocking flange 428 of the cartridge body 108 may engage the overtravel tab 506 of the dispense cap 114. The blocking flange 428 may block the overtravel tab 506 from moving, and thereby prevent or inhibit the dispense cap 114 rotating further in a first direction (in this example, the clockwise direction). In some embodiments, the engagement of the overtravel tab 506 with the blocking flange 428 occurs when the dispense cap 114 is at substantially the same position as for the engagement of the locking thread 412 with the locking tab 502. That is to say, in some embodiments, the locking thread 412 and blocking flange 428 may each engage the locking tab 502 and the overtravel tab 506 respectively, such that the dispense cap 114 can neither twist counterclockwise nor twist clockwise once the dispense cap 114 has been twisted into the locked position. When engaged, the blocking flange 428 and the overtravel tab 506 prevent rotational motion of the dispense cap 114. When further rotation motion of the dispense cap 114 is prevented and/or inhibited, translational motion of the dispense cap 102 toward the end 410 of the cartridge body 108 is also prevented and/or inhibited. Advantageously, embodiments of the present disclosure allow translational motion of the dispense cap 102 toward the end 410 of the cartridge body 108 to be halted at a very precise, predetermined distance from the end 410 of the cartridge body, such that a precise, predetermined volume of fluid is consistently dispensed from the sample preparation reservoir 202 to the one or more diagnostic test reservoirs 204. In some non-limiting examples, further rotation of the dispense cap 114 another 7 to 10 degrees in the clockwise direction (past the locked position) resulted in an additional 10 μL of fluid being dispensed from the sample preparation reservoir 202 to the one or more diagnostic test reservoirs 204. In certain embodiments, an additional 10 μL dispense is a 10% error in volume dispersed. Accordingly, embodiments of the present disclosure that implement the blocking flange 428 and the overtravel tab 506 can consistently deliver a precise volume of fluid to the one or more diagnostic test reservoirs 204, thereby increasing reliability and accuracy of the test.

In some embodiments of the present disclosure, the cartridge body 108 includes features that are advantageously positioned to improve moldability and manufacturability of the cartridge body 108. In one non-limiting example, the protrusion of the cartridge body 108 that includes the locking thread 412 and the blocking flange 428 extends around less than half of the circumference of the upper part of the cartridge body 108 (for example, approximately 170° of the circumference). In some other embodiments, the protrusion may encompass substantially more or less of the circumference of the upper part of the cartridge body 108, for example, 330° of the circumference or 45° of the circumference. In embodiments where the cartridge body 108 is a single molded plastic piece, a protrusion that encompasses less than 180° of the circumference of the cartridge body 108 may possess better moldability. This is because, in such non-limiting examples, the protrusion on which the locking thread 412 and the blocking flange 428 are positioned does not cross a parting line used during manufacturing (for example during an injection molding process).

Referring to FIGS. 5B and 5C, the plug seal 508 of the dispense cap 114 is an annular flange extending from a top interior surface of the dispense cap 114. When in a locked position, the plug seal 508 may engage the first end 120 of the cartridge body 108. For example, an outer surface of the plug seal 508 can directly contact an inner surface of the first end 120 of the cartridge body 108, as illustrated in FIG. 5C. The plug seal 508 can prevent fluid within the cartridge body 108 from exiting or leaking out of the sample preparation reservoir 202 through the first end 120. Additionally, the plug seal 508 can prevent and/or inhibit fluid within the sample preparation reservoir from contacting the threaded wall 404 and/or threads 504. Accordingly, embodiments of the present disclosure implementing a dispense cap 114 with a plug seal 508 can advantageously reduce or eliminate risk that the external environment will be contaminated with fluid in the sample preparation reservoir 202, which could include pathogens.

In embodiments of the cartridge body 108 that include the key 402, the key 402 may engage the diagnostic test apparatus. The key 402 may help a user orient the cartridge 106 correctly within the diagnostic test apparatus. Additionally or alternatively, the key 402 may be sensed by the diagnostic test apparatus to indicate insertion of the cartridge 106. Additionally or alternatively, in embodiments where each diagnostic test reservoir 204 is loaded with different reagents, for example lyophilized reagents, the key 402 may be used to orient the test container 112 so as to differentiate each diagnostic test reservoir 204.

An interior surface or wall 420 near the bottom of the cartridge body 108 may be shaped to define sides of at least one chamber, for example cylindrical chamber 206. In the embodiment illustrated in FIGS. 4A-4G, the sides of the cylindrical chambers 206 are formed by the interior surface 420. While the cartridge body 108 of illustrated embodiments includes two cylindrical chambers 206, other embodiments may include one or more cylindrical chambers 206. The cylindrical chambers 206 may include openings 418. Such openings facilitate dispense of liquid from the sample preparation reservoir 202 to the one or more diagnostic test reservoirs 204. The openings 418 may be covered by the seal 110a. In certain embodiments, each opening 418 may be covered by its own seal 110a, such that there is one seal 110a for each opening 418.

It is to be understood that the cartridge body 108 of the present disclosure is not limited two cylindrical chambers 206 as depicted in FIGS. 1-3, 4A-4G, and 7A-7E. For instance, a cartridge body 108 can be implemented with one cylindrical chamber 206. Alternatively, a cartridge body 108 can be implemented with three, four, or more cylindrical chambers 206. The number of cylindrical chambers 206 of the cartridge body 108 may correspond to the number of diagnostic test reservoirs 204 of the test container 112.

The seals 110a and 110b may include a foil material, and may be pierced by an application of mechanical force. The seals 110a and 110b need not be of the same material, but in some embodiments they may be of the same material. A seal 110b may be affixed to the test container 112 to cover the openings at a first end 434 of the test container 112, separating the sample preparation reservoir 202 and the one or more diagnostic test reservoirs 204. In one non-limiting embodiment, when the cartridge body 108 and test container 112 are joined into a single cartridge 106, the two seals 110a and 110b are pressed together. It may be desirable to attach the seal 110b to the top of the test container 112. In certain embodiments where the test container 112 holds lyophilized reagents, for example, the attachment of seal 110b can ensure moisture and/or other potential contaminants do not enter the test container 112 before the test container 112 and the cartridge body 108 are joined. Presence of moisture and/or contaminants within the test container 112 could lead to inaccurate assay results, for example false positives or false negatives. When affixed to the end 410 of the one or more cylindrical chambers 206, the seal 110a can hold fluid, for example liquid buffer, within the sample preparation reservoir 202 and cylindrical chambers 206. As illustrative examples, the seal 110a may be attached to the underside of the cylindrical chambers 206 by heat scaling, and the seal 110b may also be attached to the top of the test container 112 via heat sealing.

In some embodiments, there may be only one of either seal 110. In such embodiments, the seal 110 may be attached to cover the openings 418 of the cylindrical chambers 206 or the seal 110 may be attached to cover the first end 434 of the test container 112 before the test container 112 and the cartridge body 108 are joined. In such embodiments, the single seal 110 may keep fluid in the sample reparation reservoir 202 separate from the one or more diagnostic test reservoirs. Similarly, the single seal 110 may keep any lyophilized reagent within the diagnostic test reservoir 204 separate from the sample preparation reservoir 202.

In the example device 100, the cartridge body 108 is coupled to the test container 112 during manufacture and assembly of the device 100 prior to operation by an end user. Other embodiments can be suitably implemented. For example, in another non-limiting embodiment, the device 100 is formed of a single unitary structure that includes the cartridge body 108 integrally formed with the test container 112. In yet another non-limiting embodiment, the cartridge body 108 and the test container 112 are transported separately to an end user, and the end user couples the cartridge body 108 and the test container 112 prior to operation.

The cartridge body 108 can connect to the test container 112 using any number of coupling mechanisms, such as but not limited to a lip 406 that matingly connects to the lip 430 on the exterior surface of the test container 112. The sample preparation reservoir 202 and the one or more diagnostic test reservoirs 204, with the seal 110a and/or 110b therebetween, may be joined to form a cartridge 106. Thus, the seal 110a may define a bottom of the two cylindrical chambers formed by the interior surface 420. The seal 110b may define the top of the two diagnostic test reservoirs 204. Joining of the sample preparation reservoir 202 and the one or more diagnostic test reservoirs 204, with the seal 110a therebetween, to form a single joined structure may be accomplished by, for example, ultrasonic welding, glue, a snap-fit connection, a combination of these, or any other suitable joining mechanism. It may be desirable that the sample preparation reservoir 202 and one or more diagnostic test reservoirs 204 are joined sufficiently strongly to resist a buildup of pressure within the cylindrical chambers 206 and/or the one or more diagnostic test reservoirs 204. In embodiments where the sample preparation reservoir 202 and the one or more diagnostic test reservoirs 204 are joined via ultrasonic welding, the test container 112 may include one or more projections 310. The one or more projections 310 may be spaced around an exterior surface of the lip 430. The one or more projections 310 may aid in aligning the test container 112 against the end 410 and lip 406 of the second end 118 of the cartridge body 108 during ultrasonic welding. The one or more projections 310 may aid in centering the test container 112 relative to the lip 406 of the second end 118 of the cartridge body 108 during ultrasonic welding. For example, the one or more projections may ensure that the test container 112 is approximately or substantially equidistant from the edges of lip 406. The one or more projections 310 may thereby improve consistency and/or strength of the ultrasonic weld.

FIG. 5 illustrates the dispense cap 114, which may be coupled to the dispensing mechanism 102 according to embodiments of the present disclosure. The dispense cap 114 may include threads 504 configured to engage with the threaded wall 404 of the cartridge body 108. Additionally, in some embodiments, the dispense cap 114 includes a locking tab 502, which may engage the locking thread 412 of the cartridge body 108. Once the locking tab 502 of the dispense cap 114 has been rotated past the locking thread 412, further rotation in either direction may be prevented or inhibited, and the dispense cap 114 may be locked to the cartridge body 108.

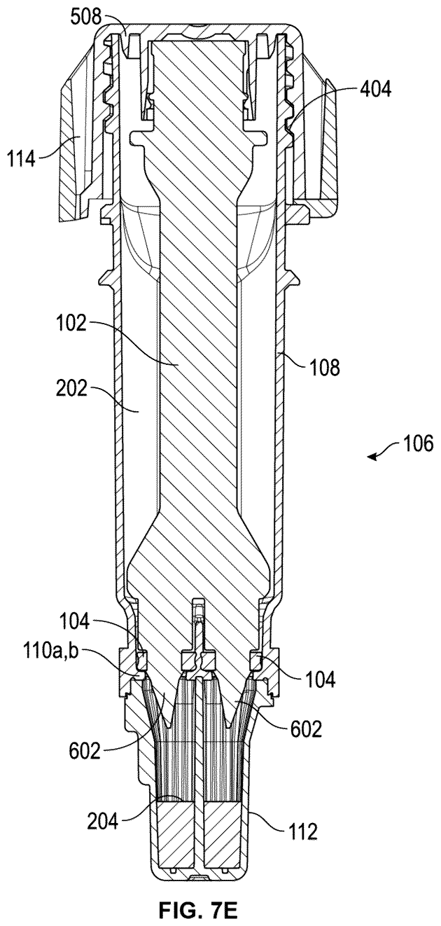

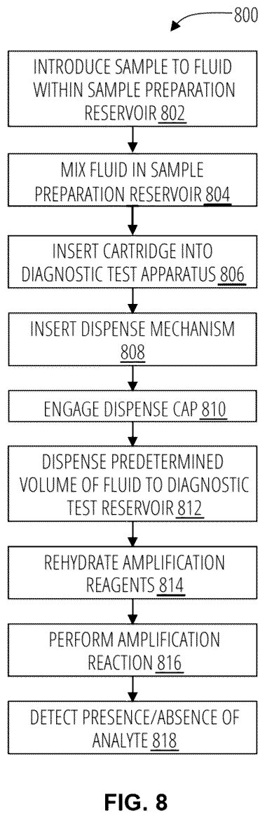

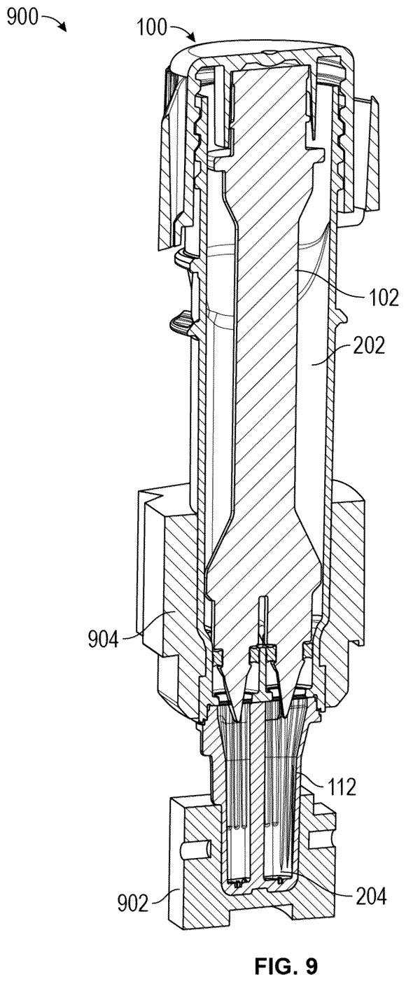

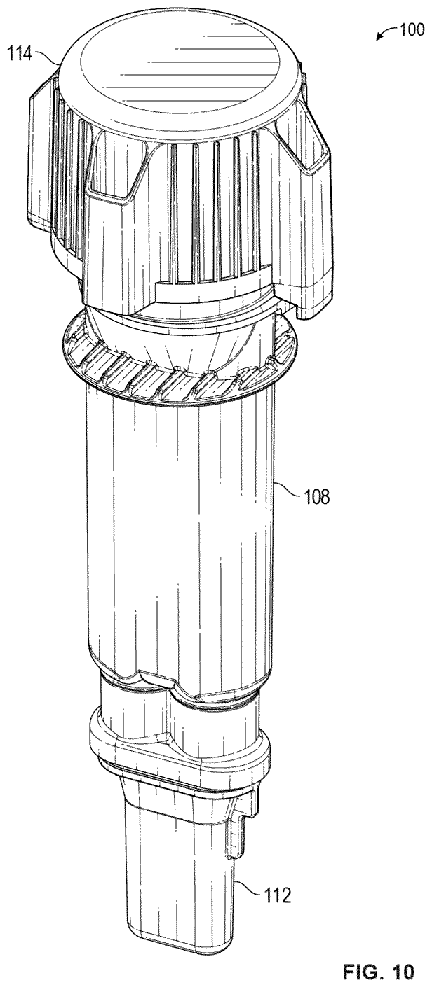

FIGS. 6A and 6B illustrate aspects of the dispensing mechanism 102. The dispensing mechanism 102 includes a shaft 604, one or more piercing members 602, and one or more sealing members 104. In embodiments of the present disclosure, the number of piercing members and scaling members 104 correspond to the number of cylindrical chambers 206 and the number of diagnostic test reservoirs 204. Accordingly, the piercing members 602, sealing members 104, cylindrical chambers 206, and diagnostic test reservoirs 204 are in a one-to-one correspondence.

The shaft 604 and the piercing member 602 of the dispensing mechanism 102 may include a plastic. The plastic may be, for example, a polycarbonate, an acrylonitrile butadiene styrene (ABS), a nylon, another thermal plastic, a polypropylene material or any other suitable material (such as, but not limited to, polyethylene). The piercing member 602 may include a spike or other relatively sharp feature sufficient to pierce a seal, such as the seal 110a. In one example, the piercing member 602 includes a spiked rod. As illustrated in FIG. 6B, the exterior profile and the cross-section of the piercing member 602 may be in a cross-shape and/or a plus-sign shape. The piercing members 602 may include chamfered or beveled surfaces. For example, in the non-limiting embodiment of FIGS. 6A and 6B, a section of each of the piercing members 602 includes a chamfered surface 614. Cross and/or plus-sign shapes may facilitate flow of fluid past the piercing member 602 and through a pierced seal 110a, as fluid may flow more easily past the concave surfaces of the piercing member 602 while the chamfered surface 614 continues to enlarge the opening. Advantageously, the cross-shape or plus-sign shape of the piercing member 602 can form an opening in the seal 110a that has a shape and size that facilitates flow of fluid from the sample preparation reservoir 202 through the seal 110a. In one non-limiting example, the shape and size of the opening created in the seal 110a does not form leaves or sections of seal material that could obstruct or impede passage of the fluid through the opening.

In addition, the cross-shape or plus-sign shape of the piercing member 602 can advantageously allow air to leave the one or more diagnostic test reservoirs 204 and enter the sample preparation reservoir 202 before the opening is fully formed in the seal 110a. For example, air can travel past the concave surfaces of the piercing member 602 while the chamfered surface 614 continues to enlarge the opening. Pressure build-up in the one or more diagnostic test reservoirs 204 that would ordinarily act to impede flow of fluid into the one or more diagnostic test reservoirs 204 can thus be reduced as the opening is being formed. This is particularly advantageous in scenarios where air in the one or more diagnostic test reservoirs 204 is pressurized. It will be understood that the above-described advantages of embodiments of the piercing member 602 are also applicable to the formation of an opening in seal 110b.

It is to be understood that the dispensing mechanism 102 of the present disclosure is not limited two piercing members 602 as depicted in FIGS. 1, and 6A-7C. For instance, a dispensing mechanism 102 can be implemented with one piercing member 602. Alternatively, a dispensing mechanism 102 can be implemented with three, four, or more piercing members 602. The number of piercing members 602 of the dispensing mechanism 102 may correspond to the number of cylindrical chambers 206 of the cartridge body 108.

The dispensing mechanism 102 may include one or more sealing members 104, for example an o-ring, a gasket, or a grommet. The sealing member 104 may encircle at least a portion of the piercing member 602. FIGS. 6A and 6B illustrate embodiments where the scaling members 104 are o-rings. FIGS. 6C-6F illustrate an alternative embodiment wherein the scaling members 104 are one or more gaskets. FIGS. 6E and 6F are top and bottom views of an alternative embodiment of the scaling members 104. In certain embodiments where the sealing members 104 are gaskets, such as the one depicted in FIG. 6D, the sealing member may be formed separately from the dispensing mechanism 102 and coupled to the dispensing mechanism 102 by pushing the gasket sealing member 104 over the piercing members 602. In some embodiments, the gasket sealing member 104 may be overmolded onto the piercing members 602 during a process of manufacturing the piercing members 602. In the non-limiting example of FIGS. 6C-6F, the gasket is a unitary piece of material forming two channels 610, each channel 610 configured to receive one piercing member 602. The gasket also includes two annular portions 612 separated by a distance.

In one example where the piercing member 602 includes a spiked rod, the scaling member includes a sealing member 104 encircling the spiked rod. The sealing member 104 may be configured to directly contact the interior surface 420. In embodiments in which the sealing member 104 includes two o-rings, substantially the entire circumference of each o-ring can be in direct contact with the interior surface 420 of a cylindrical chamber 206 of the cartridge body 108. In some instances, such as the non-limiting example illustrated in FIGS. 6A and 6B, each o-ring includes two annular portions separated by a distance. Substantially the entire circumference of each annular portion 612 can be in direct contact with the interior surface 420 of a cylindrical chamber 206 of the cartridge body 108. In such instances, the presence of two independent annular portions can form a two-part seal against the interior surface 420, providing redundancy in the event one annular portion does not form an effective seal against the interior surface. In embodiments in which the sealing member 104 includes a gasket such as that illustrated in FIGS. 6C-6F, substantially the entire circumference of each annular portion 612 is in direct contact with the interior surface 420 of a cylindrical chamber 206 of the cartridge body 108. In such embodiments, the presence of two independent annular portions 612 separated by a distance can form a two-part seal against the interior surface 420, providing redundancy in the event one annular portion 612 does not form an effective seal against the interior surface 420.

The sealing member 104 may include an elastomeric material suitable for creating a liquid-impenetrable, or substantially liquid-impenetrable, seal when pressed against the material of the cartridge body 108. In some cases, the sealing member 104 includes a compressible material. In some non-limiting examples, the sealing member 104 includes a rubber, a butyl rubber, a thermoplastic vulcanizate (TPV), and/or a thermoplastic elastomer (TPE). In certain embodiments where the sealing member 104 is an o-ring, the sealing member 104 may include, for example, a 70 shore A butyl rubber. In certain embodiments where the sealing member 104 is a gasket (either a gasket that is formed separately before coupling to the dispense mechanism 102 or a gasket that is overmolded on the dispense mechanism), the sealing member 104 may include a 60 shore A TPV. It will be understood that many other materials can be suitably implemented in accordance with the present disclosure. The dispense cap 114 may be coupled to the dispensing mechanism 102. For example, the dispense cap 114 may be coupled to the dispensing mechanism 102 such that dispense cap 114 can rotate about the longitudinal axis of the dispensing mechanism 102. In one non-limiting embodiment, an end 606 of the dispensing mechanism 102 engages with an internal ring 510 in an interior top surface of the dispense cap 114 with a snap-fit mechanism that allows the dispensing mechanism 102 to rotate freely relative to the dispense cap 114.

In reference to FIGS. 4B and 4C, in embodiments having two or more cylindrical chambers 206, there may be a portion 414 of the interior surface that separates the two cylindrical chambers 206. The portion 414 of the interior surface between the two cylindrical chambers 206 may be formed to include a negative space, for example a notch 416. The notch 416 may, at least in part, define the predetermined volume of fluid that is dispensed from the sample preparation reservoir 202 to the one or more diagnostic test reservoirs 204. The depth of the notch 416 may thus be altered to tune the predetermined volume that is dispensed from the sample preparation reservoir 202 to the one or more diagnostic test reservoirs 204.

The predetermined volume of fluid that is dispensed to the one or more diagnostic test reservoirs 204 is defined by at least three variables: the radius of the cylindrical chamber 206, a height H of the cylindrical chamber 206 measured between the lower surface 424 and the lowest point of the notch 416, and the volume displaced by the piercing member 602. The depth of the notch 416, indicated by distance D in FIG. 4C, is inversely related to the predetermined volume that is dispensed because the depth of the notch 416 impacts the height H at which the one or more sealing members 104 engage the interior surface between the two cylindrical chambers 206. Three non-limiting examples are described below to illustrate the effect of the notch 416 on the predetermined volume of fluid that is dispensed. For purposes of these three examples, the only change in dimensions relating to the predetermined volume of dispensed fluid is to the depth D of the notch 416.

In a first non-limiting example illustrated in FIGS. 4B and 4C, the depth D of the notch 416 is approximately 0.2 mm for an embodiment where a volume of about 100 μL of fluid is dispensed from each cylindrical chamber 206 to a corresponding diagnostic test reservoir 204. In a second non-limiting example, the depth D of the notch 416 is approximately 0.1 mm, and a volume greater than about 100 μL of fluid is dispensed from each cylindrical chamber 206 to a corresponding diagnostic test reservoir 204. This is because, in this second non-limiting example, the depth D of the notch 416 is less than the depth D of the notch 416 in the first example. Stated another way, in the second example the one or more sealing members 104 engage the interior surface between the two cylindrical chambers 206 at a height H that is greater than the height H in the first example, thereby enclosing a larger volume of fluid within the two cylindrical chambers 206. In a third non-limiting example, the depth D of the notch 416 is approximately 0.4 mm, and a volume less than about 100 μL of fluid is dispensed to the one or more diagnostic test reservoirs 204. This is because, in this third non-limiting example, a depth D of the notch 416 is greater than a depth D of the notch 416 of the first example. Stated another way, in the third example the one or more scaling members 104 engage the interior surface between the two cylindrical chambers 206 at a height H that is less than the height H in the first example, thereby enclosing a smaller volume of fluid within the two cylindrical chambers 206. In some embodiments, the depth D of the notch 416 is between approximately 0 mm-2 mm, between approximately 0 mm-1.5 mm, between approximately 0 mm-1 mm, between approximately 0.1 mm-0.4 mm, though in some cases other values or ranges may be used. In a non-limiting example of the present disclosure in which approximately 100 μL of fluid is dispensed to each diagnostic test reservoir 204, the depth D of the notch 416 is between about 0.1 mm and about 0.4 mm.

In embodiments where the dispensing mechanism 102 includes two or more piercing members 602, the dispensing mechanism 102 may include a slot 608. The slot 608 is an empty space in the dispensing mechanism 102. The slot 608 may allow the one or more piercing members 602 and one or more sealing members 104 to pass beyond the portion 414 of the interior surface between the two cylindrical chambers 206.

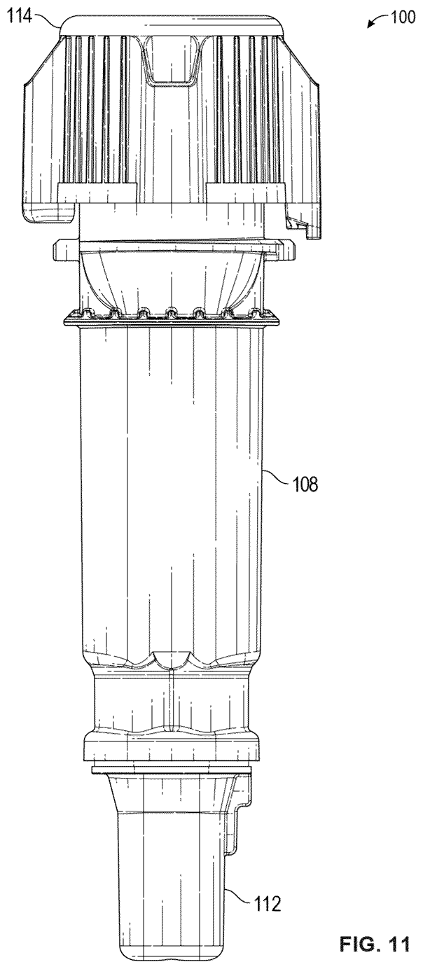

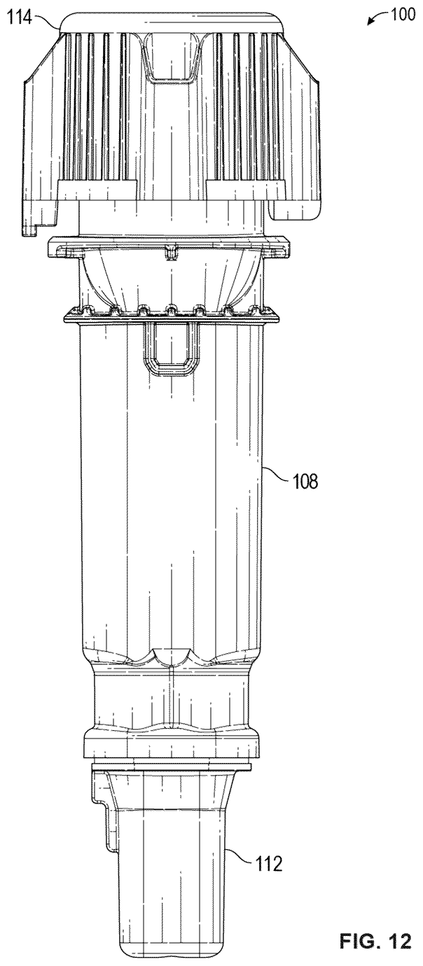

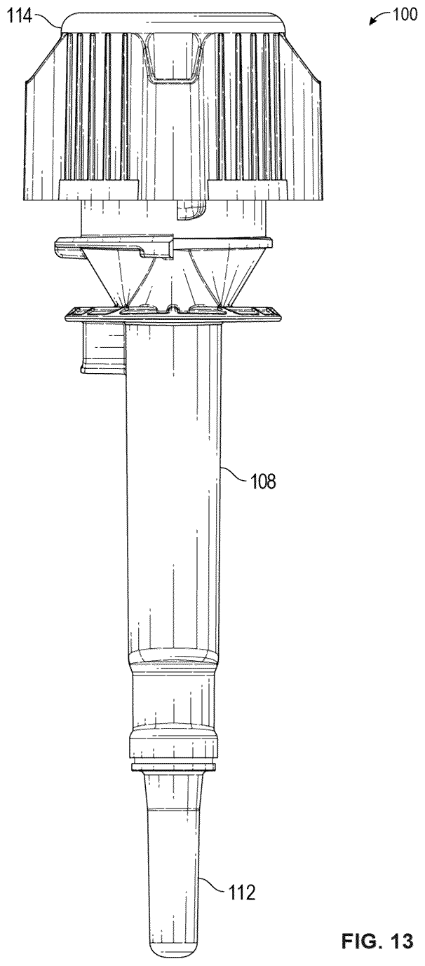

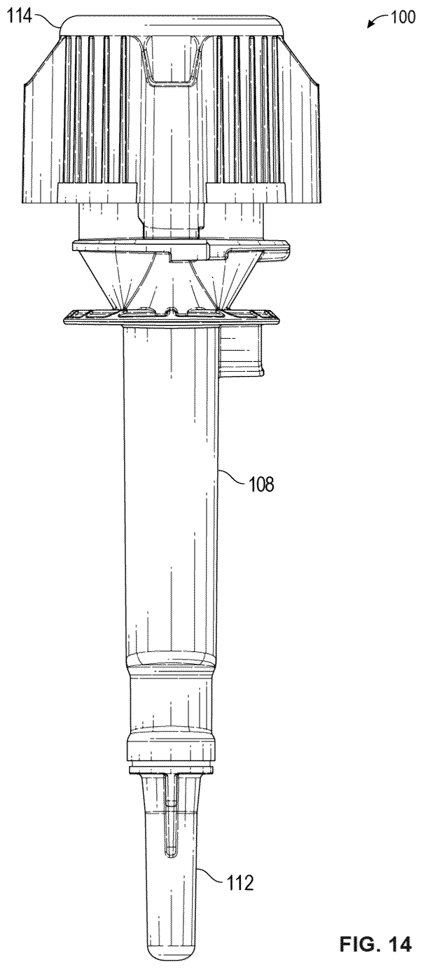

FIGS. 7A-7E illustrate four different positions of the dispensing mechanism 102 within the sample preparation reservoir 202 during a dispense operation according to the present disclosure. This action involves movement of the dispensing mechanism 102 relative to the cartridge body 108 to break the seal 110a and/or seal 110b, pushing a predetermined amount volume of fluid into the one or more diagnostic test reservoirs 204. Advantageously, embodiments of the devices, systems, and methods of the present disclosure dispense the predetermined amount of volume of fluid when one or more sealing members directly contact the interior surface defining the sides of the sample preparation reservoir 202 as the dispensing mechanism 102 translates along the longitudinal axis 108.

FIG. 7A illustrates the dispensing mechanism 102 inserted into the sample preparation reservoir 202, prior to engaging the threaded wall 404 with the dispense cap 114. The dispensing mechanism 102 can be placed in this position manually, by inserting the dispensing mechanism into the cartridge body 108 from above. The seals 110a and 110b are intact. As discussed, the dispensing mechanism 102 may be coupled to a dispense cap 114. The dispense cap 114 is configured to engage a threaded wall 404 of the sample preparation reservoir 202. The scaling members 104 are positioned above the cylindrical chambers 206 and have therefore not yet engaged the cylindrical chambers 206. However, as the sample preparation reservoir 202 is wider than it is deep (i.e. the top-down cross-section of the sample preparation reservoir is oblong), the interior of the sample preparation reservoir 202 orients dispensing mechanism 102 such that the piercing members 602 are substantially aligned with the cylindrical chambers 206 even when the piercing members 602 are positioned higher than the cylindrical chambers 206 within the cartridge body 108.

FIG. 7B illustrates the dispensing mechanism 102 after it has pierced the seal 110a and/or seal 110b. Relative to the position depicted in FIG. 7A, the dispensing mechanism 102 may be in the position of FIG. 7B after engaging the threaded wall 404 with the dispense cap 114 and continued twisting of the dispense cap 114. As discussed, the dispense cap 114 is coupled to the upper end 606 of the shaft 604 of the dispensing mechanism 102. This coupling allows the dispense cap 114 to rotate freely in relation to the shaft 604 and the piercing members 602. Thus, interaction of threaded wall 404 with threads 504 translates the twisting of the dispense cap 114 into vertical translational motion of the dispensing mechanism 102 along the longitudinal axis 108. As the cap 114 is tightened by clockwise twisting relative to the cartridge body 108, the dispensing mechanism 102 translates downward. In this position, the dispense cap 114 has not yet engaged the locking tab 502, and can still rotate with respect to the dispensing mechanism 102 and the cartridge body 108.

As illustrated in FIG. 7B, the dispensing mechanism 102 includes two scaling members 104 and two piercing members 602 configured to interact with the two cylindrical chambers 206 formed by the interior surface 420. When the dispense cap 114 is threaded on to the cartridge body 108 and twisted, the dispensing mechanism 102 is translated downward such that the piercing members approach and then break the seals 110a and 110b. This translation forces the piercing member 602 through the seal 110a.

There may be a buildup of pressure below the one or more sealing members 104, within the one or more diagnostic test reservoirs 204, as any air within the diagnostic test reservoirs 204 is compressed as the dispensing mechanism 102 translates downward. The threaded wall 404 and the threads 504 may be configured to resist upward force due to this buildup of pressure. Once the dispense cap 114 locks with the locking thread 412, the interaction between the locking thread 412 and the dispense cap 114 may resist upward motion as well. Additionally, the bond between the test container 112 and the cartridge body 108 should be sufficiently strong such that it does not break due to this buildup of pressure.

FIG. 7C depicts the dispensing mechanism 102 and the cartridge body 108 shortly after the piercing members 602 have pierced the seal 110a, but before fluid has travelled into the one or more diagnostic test reservoirs 204. The sealing members 104 have engaged the interior surface 420 of the cylindrical chambers 206. The lower face of each scaling member 104 has travelled below the notch 416, such that each sealing member 104 creates a complete seal with the interior surface 420 of the cylindrical chamber 206, preventing or substantially preventing any fluid from flowing relative to the sealing member 104; that is to say that fluid cannot flow from below the sealing member 104 to above the sealing member 104, and fluid cannot flow from above the scaling member 104 downward below the sealing member 104. Because the lowest point of notch 416 defines a height at which the top plane of the cylindrical chambers 206 can be defined, the predetermined volume is not defined until the lower face of the sealing members 104 have passed just below the notch 416. At the instant each piercing member 602 pierces the seal 110a, the predetermined volume (shaded area) is defined by the interior surface 420 of the cylindrical chamber 206, the sealing members 104, the piercing member 602, and the seal 110a. As the dispensing mechanism 102 translates further downward, the scaling members 104 and the piercing members 602 force the predetermined volume to flow through the pierced seal 110a into the diagnostic test reservoir 204.

Once the predetermined volume has been forced through the pierced seal 110a, the capillary grooves 304 of the one or more diagnostic test reservoirs 204 are configured to promote flow of the predetermined volume. The capillary grooves 304 can promote flow from the end 312 of the test container 112 toward the end 314 of the test container 112, so that the predetermined volume is collected where the window regions 308 are located. In some embodiments, the capillary grooves 304 can promote downward flow of the predetermined volume. The capillary grooves 304 can prevent and/or inhibit fogging and/or droplets of the predetermined volume from adhering to inner surfaces of the test container 112.

As depicted in FIGS. 7D and 7E, the entire dispensing mechanism 102 translates downward relative to the cartridge body 108 until the predetermined volume, depicted as the shaded region at the bottom of the diagnostic test reservoirs 204 in FIG. 7E, has been fully and/or substantially dispensed into the diagnostic test reservoir 204. In some embodiments, there may be some volume of fluid remaining within the cylindrical chambers 206 when the dispense cap 114 locks. In some embodiments, the sealing members 104 may be flush against the lower surface 424 of the cylindrical chamber 206 once the predetermined volume has been dispensed into the diagnostic test reservoirs 204. In some embodiments, the sealing members 104 are in direct contact with the lower surface 424 of the cylindrical chamber 206 once the predetermined volume has been dispensed into the diagnostic test reservoirs 204. The dispense cap 114 is configured to lock against the locking thread 412 and the blocking flange 428 as the last of the predetermined volume is expelled from the one or more cylindrical chambers 206. This inhibits and/or prevents rotation of the dispense cap 114 relative to the cartridge body 108 and shaft 604, thereby preventing further and/or reverse translational motion of the dispensing mechanism 102 relative to the cartridge body 108. These and other features can allow embodiments of the diagnostic test reservoir 100 according to the present disclosure to accurately and consistently dispense no less than and no more than a predetermined volume of fluid into the diagnostic test reservoir.

Because the piercing members 602 and sealing members 104 are locked in place as described above, the predetermined volume dispensed to the one or more diagnostic test reservoirs 204 is locked within the test container 112. The piercing members 602 and sealing members 104 block passage of the predetermined volume of fluid from the diagnostic test reservoirs 204. Additionally, because the piercing members 602 and sealing members 104 are locked in place, no additional fluid nor other potential contaminants exterior to the diagnostic test device can enter the one or more diagnostic test reservoirs 204 or the sample preparation reservoir 202. As described below in reference to sample processing, the predetermined volume of fluid locked within the one or more diagnostic test reservoirs may undergo processing, for example thermal processing and/or optical processing. Such processing may assist in generating a result indicating the presence or absence of one or more target analytes within a sample introduced to the diagnostic test device 100.

### Sample Processing Using the Diagnostic Test Device

FIG. 8 illustrates an example process 800 of using a diagnostic device 100 in accordance with the present disclosure. The process can be implemented using illustrated embodiments, such as those depicted by FIGS. 1-7C and 9, as well as other embodiments in accordance with the present disclosure. In use, the cartridge 106 is provided with a transportation cap 116 engaging the threaded wall 404 of the cartridge body 108. The transportation cap 116 is removed from the cartridge body 108. For example, instructions for use of the device 100 can instruct the user to unthread the transportation cap 116 from the cartridge body 108. At block 802, the swab is inserted into the sample preparation reservoir 202 of the cartridge body 108 to deposit a sample. Instructions for use can instruct the user to swirl the tip of the swab in the sample preparation reservoir 202 according to a predefined protocol, for example a certain number of rotations and/or for a certain duration.

It will be understood that the sample can be dispensed into the sample preparation reservoir 202 using any suitable method. For example, a sample can be dispensed (such as by pipetting the sample) directly into the sample preparation reservoir 202 without the use of a swab. Liquid sample may include urine, blood, interstitial fluid, saliva, or any other suitable sample material. It will also be understood that embodiments of the present disclosure are not limited to liquid samples, and any suitable sample, including solid and gas samples, can be added to the sample preparation reservoir 202.

In this example implementation, the swab is then removed from the sample preparation reservoir 202 and disposed. The transportation cap 116 may then be threaded back onto the cartridge body 108. In another example, the transportation cap 116 is not threaded back onto the cartridge body 108.

The process next moves to block 804, where the cartridge 106, with the transportation cap 116 attached, is inverted or otherwise agitated to mix the fluid sample, dispersing the sample within the sample preparation fluid in the sample preparation reservoir 202. When the cartridge 106 is oriented such that the end 120 including the threaded wall 404 is pointed up (i.e., the cartridge 106 is not inverted), fluid sample may pool without air bubbles in the cylindrical chambers 206 of the sample preparation reservoir 202 under the influence of gravity. After mixing, it may be desirable that fluid sample pool in the cylindrical chambers 206 without air bubbles so that the intended volume of fluid can be dispensed to the sample preparation reservoirs 202. In embodiments where the transportation cap 116 is not re-engaged with the cartridge body 108, block 804 can include mixing the fluid sample without inverting the cartridge body 108.

In certain examples, the sample preparation fluid may be heated prior to introducing the swab and mixing the sample in the sample preparation fluid. In other examples, the sample preparation fluid is heated after mixing with the sample. In embodiments where the sample is added directly to the sample preparation reservoir 202, the sample may be added before or after heating the sample preparation solution. If present in the sample, particles containing analyte of interest may be lysed in the solution by the chemical action and/or elevated temperature of the sample preparation fluid.

The process next moves to block 806, where the cartridge 106 is inserted into the diagnostic test apparatus. The sample in the sample preparation fluid then undergoes processing. The transportation cap 116, if present, may be removed before or after the cartridge 106 is placed within the diagnostic test apparatus. The transportation cap 116 does not include a locking tab to engage the locking thread 412 of the cartridge body 108, and therefore cannot lock to the cartridge body 108 like the dispense cap 114.

The process next moves to block 808, where the dispensing mechanism 102 is inserted into the sample preparation reservoir 202. The dispensing mechanism 102 is lowered vertically through the sample preparation reservoir 202 toward the seal 110a, such that each piercing member 602 and scaling member 104 align or substantially align with a corresponding cylindrical chamber 206. Fluid can flow around and past the dispensing mechanism 102 as the dispensing mechanism 102 is lowered into the sample preparation reservoir 202.

The process then moves to block 810, where the dispense cap 114 of the dispensing mechanism 102 engages the sample preparation reservoir 202, in this example with the threaded wall 404 of the sample preparation reservoir 202.

Once the dispense cap 114 has descended down the threaded wall 404 a certain distance, the dispensing mechanism 102 will be at the position illustrated in FIG. 7C. The scaling members 104 engage the top of the two cylindrical chambers 206 formed by the interior surface 420 of the sample preparation reservoir 202. When the scaling members 104 engages the top of the two cylindrical chambers 206, the piercing member 602 is above the seal 110a, which separates the sample preparation reservoir 202 and the one or more diagnostic test reservoirs 204. The interior surface 420, the seal 110a, the scaling members 104, and the piercing member 602 together define a predetermined volume of fluid. In the illustrated embodiment, these features define two fluidically separated predetermined volumes of fluid, each volume associated with one of the two cylindrical chambers 206. The scaling members 104 form a fluid seal with interior surface 420, thereby trapping the predetermined volume(s) of fluid. Fluid present above the sealing members 104 within the sample preparation reservoir 202 cannot enter the two cylindrical chambers 206 after the sealing members 104 engage the interior surface 420.

In certain examples, the predetermined volume of fluid that is scaled in each cylindrical chamber 206 is up to 10 μL of liquid, 25 μL of liquid, up to 50 μL of liquid, up to 70 μL of liquid, up to 75 μL of liquid, up to 100 μL of liquid, up to 125 μL of liquid, up to 130 μL of liquid, up to 150 μL of liquid, up to 200 μL of liquid, up to 250 μL of liquid, up to 300 μL of liquid, up to 350 μL of liquid, up to 400 μL of liquid, up to 450 μL of liquid, up to 500 μL of liquid, up to 1000 μL of liquid, or any value or range within or bounded by any of these ranges or values, although values outside these values or ranges can be used in some cases. Additionally or alternatively, in some examples the predetermined volume of fluid is about 100 μL of liquid.

The dispense cap 114 is then further rotated to translate the dispensing mechanism 102 to reach the position illustrated in FIG. 7B. The piercing member 602 has pierced the seal 110a and the seal 110b between the sample preparation reservoir 202 and the one or more diagnostic test reservoirs 204. Further translation causes the scaling members 104 to slide along the interior surface 420 of the sample preparation reservoir 202, acting as a piston that forms a sliding seal with the two cylindrical chambers 206 of the sample preparation reservoir 202. For example, a liquid-tight seal can be formed between the sealing members 104 and the interior surface 420 as a result of a close fit between the sealing members 104 and the interior surface 420 inside the two cylindrical chambers 206 of the sample preparation reservoir 202.

The method next moves to block 812, where the seals 110a, 110b are pierced, and the predetermined volumes of fluid are pushed from within the cylindrical chambers 206 into the diagnostic test reservoirs 204 by the downward motion of the dispensing mechanism 102. This dispense action forces the predetermined volume of fluid into the diagnostic test reservoirs 204. The seals 110a, 110b ensure that there is no communication of fluid between the sample preparation reservoir 202 and the one or more diagnostic test reservoirs 204 until the dispensing action. Once the scaling members 104 have formed a seal with the interior surface 420, fluid in the sample preparation reservoir that is above the sealing members 104 is not dispensed into the one or more diagnostic test reservoirs 204. Thus, in embodiments of systems and methods of the present disclosure, a first portion of the total fluid volume that is present in the sample preparation reservoir 202 is dispensed to the diagnostic test reservoirs 204, while a second portion of the total fluid volume that is present in the sample preparation reservoir 202 is not dispensed to the diagnostic test reservoirs 204. In certain embodiments where there are two cylindrical chambers 206 each capable of dispensing about 100 μL, there may be a volume of 500 μL or more of fluid in the sample preparation reservoir 202. In certain embodiments where there are two cylindrical chambers 206 each capable of dispensing about 100 μL, there may be between 1 and 3 mL of fluid in the sample preparation reservoir 202. In some embodiments, the total fluid volume that is present in the sample preparation reservoir 202 is 1-300 times greater than the volume of the predetermined volume dispensed to the diagnostic test reservoirs 204. In some embodiments, the total fluid volume that is present in the sample preparation reservoir 202 is 5-50 times greater than the volume of the predetermined volume dispensed to the diagnostic test reservoirs 204.

As described above, the diagnostic test reservoirs 204 include one or more capillary grooves 304 configured to promote flow of the predetermined volume of fluid from an end of the diagnostic test reservoirs 204 (for example, the end 312 of the test container 112) toward another end of the diagnostic test reservoirs 304 (for example, toward the end 314 of the test container 112). Ensuring that a consistent volume of fluid is dispensed into the diagnostic test reservoirs 204 may reduce variability of assay results. Consistent and reliable dispersion of fluid volume to the bottom of the diagnostic test reservoirs may also ensure a higher likelihood that sufficient sample material, for example genomic material, is available to the assay reaction to ensure an accurate test result. Accordingly, in embodiments of the present disclosure, block 812 includes moving fluid along the one or more capillary grooves 304 from the first end 434 toward the bottom portion 436 of the test container 112.

In this non-limiting example of the present disclosure, the one or more diagnostic test reservoirs 204 includes two receiving chambers, together forming a test container 112. Each receiving chamber of the test container 112 is configured to align with a cylindrical chamber 206 of the sample preparation reservoir 202. The diagnostic test reservoir 204 can be heated to perform an amplification reaction in fluid dispensed into the diagnostic test reservoir 204. Optical fluorescence signals from the diagnostic test reservoir 204 can be detected through the walls of the test container 112.

In non-limiting embodiments of the present disclosure, the dispensing mechanism 102 freely moves along a longitudinal axis of the sample preparation reservoir 202, up until a point where a locking tab engages a locking thread, as described in further detail below. The fluid in the sample preparation reservoir 202 flows relative to the dispensing mechanism 102 as the dispensing mechanism 102 is lowered along the longitudinal axis of the sample preparation reservoir 202. In non-limiting examples of the present disclosure, the dispensing mechanism 102 and dispense cap 114 are the only movable components of the diagnostic test device 100 during operation by a user. The entire dispensing mechanism 102 translates in a single motion, downward along the longitudinal axis of the diagnostic test reservoir 204, until translation of the entire dispensing mechanism 102 is arrested as described above. The downward motion of the dispensing mechanism 102 first defines a predetermined volume of fluid bounded by the interior surface 420 of the sample preparation reservoir 202, the piercing member 602 of the dispensing mechanism 102, the scaling members 104 of the dispensing mechanism 102, and the seal 110a. The additional downward motion of the dispensing mechanism 102 next pierces the seals 110a, 110b with the piercing member 602. Further downward motion of the dispensing mechanism 102 finally dispenses the predetermined volume of fluid sample into the diagnostic test reservoir 204 through the piston action of the dispensing mechanism together with the seal formed with sealing members 104. One predetermined volume of fluid sample is thereby dispensed into a single diagnostic test reservoir 204.

Simultaneous with the downward motion of the dispensing mechanism 102 along the longitudinal axis of the sample preparation reservoir 202, rotation of the dispense cap 114 about the longitudinal axis of the sample preparation reservoir 202 causes the locking thread 412 of the cartridge 106 to engage with the locking tab 502 of the dispense cap 114. During the last rotation of the cap 114 to cause the piercing members 602 to pierce the seals 110a, 110b, the locking tab 502 on the dispense cap 114 rotates past the end of the locking thread 412. The locking thread 412 then substantially prevents and/or inhibits rotational motion of the dispense cap 114 in either direction, which in turn substantially prevents and/or inhibits translational motion of the dispensing mechanism 102. It may be desirable that the locking thread 412 locks to the top of the cartridge 106 so that the fluid in the sample preparation reservoir 202 remains sealed during and after a test operation. In addition, embodiments of this locking mechanism according to the present disclosure can advantageously lock the dispensing mechanism 102 in place to prevent any further movement of liquid and/or reagents between the sample preparation reservoir 202 and the diagnostic test reservoir 204.

In devices, systems, and methods according to the present disclosure, the dispensing mechanism 102 is a monolithic, single-piece structure that is the only movable component within the sample preparation reservoir 202, thereby reducing the possibility of alignment errors during scaling of the sealing members 104 and dispense of fluid into the diagnostic test reservoir 204. In embodiments of the present disclosure, the sealing members 104 easily align and reliably seat within the two cylindrical chambers 206. There is a single stroke motion that causes the downward translation of the dispensing mechanism 102, resulting in the dispense action. Advantageously, consistent and reliable scaling of the sealing members 104 during the dispense action contribute to a consistent and precise sub-volume of fluid in the sample preparation reservoir 202 being dispensed into the diagnostic test reservoir 204. This can advantageously contribute to more consistent and more accurate testing for the presence, absence, or quantity of an analyte of interest in the fluid that is dispensed into the diagnostic test reservoir 204.

The method next moves to block 814, where the predetermined volume of fluid dispensed into the diagnostic test reservoir 204 may rehydrate lyophilized reagents if present within the diagnostic test reservoir 204. As described above, embodiments of the present disclosure can include a test container 112 having one or more capillary grooves 304 that can advantageously increase the volume of fluid that rehydrates lyophilized reagents, if present, in the diagnostic test reservoir 204. The combination of the predetermined volume of the fluid and the rehydrated reagents within the diagnostic test reservoir 204 is referred to herein as the amplification fluid. It will be understood that embodiments of the present disclosure are not limited to rehydrating reagents using the dispensed fluid, or even to providing reagents in the diagnostic test reservoir 204. Accordingly, in some non-limiting embodiments, the composition of fluid dispensed into the diagnostic test reservoir 204 is the same as the composition of fluid that is tested for the presence, absence, or quantity of an analyte of interest in the diagnostic test reservoir 204. In accordance with the present disclosure, the fluid and rehydrated reagents within the diagnostic test reservoir 204 may be mixed. In some embodiments, beads, for example magnetic beads, included in the lyophilized reagents can be agitated to facilitate mixing of the diagnostic test reservoir 204. In such embodiments, mixing using the beads may continue as a reaction proceeds in accordance with block 816, or as detection occurs in accordance with block 818.

Once reagents have been rehydrated, the method moves to block 816 where a reaction is performed in the amplification fluid in the diagnostic test reservoir 204. The reaction can include an amplification reaction. The reaction can include an assay. The reaction may involve applying heat to the diagnostic test reservoir 204, which is transferred to the fluid to facilitate an isothermal amplification reaction. In other cases, the amplification reaction includes cyclical heating to perform an amplification reaction. It will be understood that these example reactions and assays are not limiting and any suitable reaction can be performed in fluid in the diagnostic test reservoir 204.

The method ends at block 818, where the presence or absence of an analyte of interest is detected. The analyte of interest can be detected as the amplification reaction proceeds (for example, during a real-time PCR test) or at the termination of the amplification reaction. The presence or absence of an analyte may be detectable via a fluorescence signal generated during the amplification reaction, for example. Advantageously, embodiments of the present disclosure including a test container 112 having one or more capillary grooves 304 can detect the presence, absence, and in some cases, quantity, of an analyte of interest with greater specificity and/or sensitivity.

Methods of Using a Diagnostic Test Device with a Diagnostic Test Apparatus

In some examples, before or after the dispense action has occurred as described herein, the diagnostic test device 100 may be introduced into a diagnostic test apparatus 900. The device may be inserted into one or more heat blocks 902, 904 of the diagnostic test apparatus 900 configured to accept the diagnostic test device 100. A diagnostic test device 100 having a transportation cap 116 or a dispense cap 114 may be inserted into the diagnostic test apparatus 900.

In one non-limiting embodiment, the diagnostic test apparatus 900 applies heat using heat block 902 to the amplification fluid in the diagnostic test reservoir 204 to perform an amplification reaction. The diagnostic test apparatus 900 also directs optical signals to the diagnostic test reservoir 204, and receives optical signals from the diagnostic test reservoir 204 to detect an analyte of interest, if present, in the amplification fluid within the diagnostic test reservoir 204. The diagnostic test apparatus 900 may use one or more image sensors (not illustrated) to optically scan a portion of the test container 112, for example the bottom portion 436 of the test container 112. Such scanning may be used to detect and/or measure a positive control reporter within the amplification fluid. Measurement of the positive control reporter can confirm the dispensing action and that the amplification reaction is capable of proceeding as intended. Such scanning may also be used to detect and/or measure the progress of the test assay reaction. For example, the diagnostic testing apparatus 900 may optically scan the bottom portion of the diagnostic test reservoir 204 to detect and/or measure changes in fluorescence indicative of an ongoing amplification reaction due to the presence of an analyte. As described above, embodiments of the present disclosure are not limited to real-time detection during a reaction, and in some cases, detection is performed when the reaction is complete.

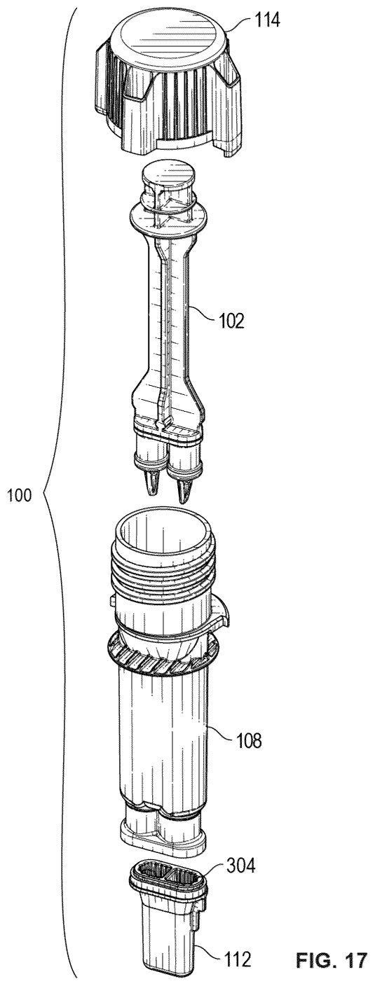

FIG. 9 illustrates a cross-sectional view of the diagnostic test device 100 received in one or more heat blocks 902, 904 of the diagnostic testing apparatus 900. The diagnostic test device 100 includes the dispensing mechanism 102 received in the sample preparation reservoir 202. In this non-limiting example, the test container 112 is received in a first heat block 902 of the diagnostic testing apparatus 900, and the sample preparation reservoir 202 is received in a second heat block 904 of the diagnostic testing apparatus 900. The second heat block 904 can apply heat to the cartridge body 108 to facilitate preparation of a sample for an assay or reaction in a fluid in the sample preparation reservoir of the cartridge body 108. The fluid contained within the sample preparation reservoir 202 may be heated as the cartridge body 108 is heated. After a sub-volume of the fluid in the sample preparation reservoir 202 is dispensed into the test container 112, the heat block 902 can apply heat to the test container 112 to perform an amplification reaction in the amplification fluid present in the test container 112. Windows within the heat bock 902 (not illustrated in this cross-sectional view) can allow optical signals to be directed to the one or more diagnostic test reservoirs 204, and for optical signals to be received from the one or more diagnostic test reservoirs 204, to detect an analyte of interest, if present, in the amplification fluid.

One or more optical sensors incorporated within the diagnostic testing apparatus 900 can capture fluorescence signals emitted from the amplification fluid during or after the amplification reaction. The digital output from the one or more image sensors can be used to confirm the test assay progression and confirm the correct release and flow of test reagents within the cartridge such that the integrity of the test can be confirmed by the controller and used to improve the reliability and accuracy of the test result.

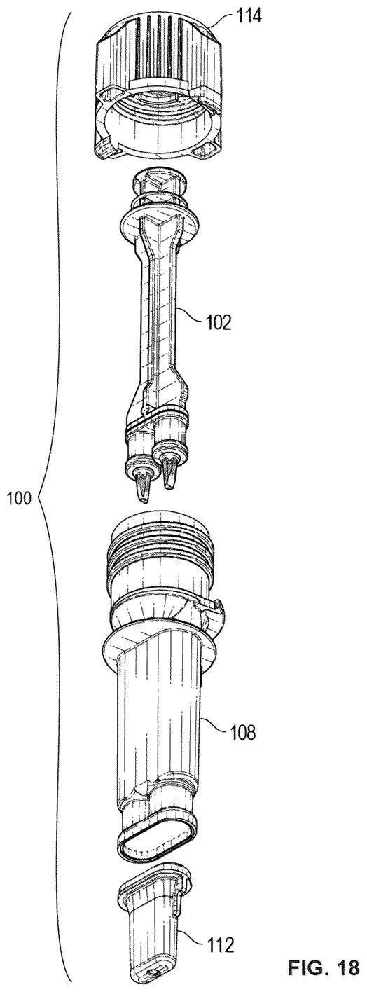

FIGS. 10-18 illustrate perspective, front, rear, left, right, top, bottom, top exploded, and bottom exploded views, respectively, of the diagnostic test device 100 including a cartridge body 108, test container 112, and dispense cap 114. As discussed above with reference to FIGS. 3A-3C, 3F-3H, and 4H, the test container 112 includes capillary grooves 304.

### Manually Operated, Visually Read, Non-Instrumented Operation of a Diagnostic Test Device

In some applications, the diagnostic test device 100 can be used manually without an instrument. For example, in some embodiments, the diagnostic test device 100 is held in one hand, and the transportation cap 116 removed with the other hand, the sample is added, the dispensing mechanism 102 is inserted into the cartridge body 108, and the dispense cap 114 is fitted to cartridge body 108 and rotated closed. In some such embodiments, where the diagnostic test reservoir(s) 204 are visually transparent, the dispensing of fluid into the diagnostic test reservoir(s) 204 can be visually observed, and a color or turbidity change observed over time to provide a diagnostic test readout or display. This approach uses the advantages of operating with a fully sealed cartridge 106 once the sample is added and internally dispensing a measured volume of prepared sample fluid into the diagnostic test reservoir(s) 204 without the use of external fluid transfer steps.

Optionally, a stand may be provided to support the diagnostic test device 100 for the purpose of removing the transportation cap 116, adding the sample, inserting the dispensing mechanism 102, and fitting, closing, and locking the dispense cap 114 to the cartridge body 108.

Optionally, a heater block may be provided to provide temperature control of the sample preparation reservoir 202 and diagnostic test reservoir(s) 204 of the diagnostic test device 100, but the diagnostic test device 100 is manually withdrawn to observe the test result visible in one or more diagnostic test reservoir(s) 204. In some applications, the heater block may include a window making the diagnostic test reservoir(s) 204 visible. In such applications, the diagnostic test device 100 need not be withdrawn from the heating block to observe the test result.

### Terminology

The features termed “capillary groove” herein may also be referred to as “capillary channel” and/or “capillary indentation.” As a non-limiting example, a groove can be a long, narrow cut or depression, especially one made to guide motion.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount.

The term “and/or” as used herein has its broadest least-limiting meaning which is the disclosure includes A alone, B alone, both A and B together, or A or B alternatively, but does not require both A and B or require one of A or one of B. As used herein, the phrase “at least one of” A, B, “and” C should be construed to mean a logical A or B or C, using a non-exclusive logical or.

Conditional language used herein, such as, among others, “can,” “could,” “might,” “may,” and the like, unless specifically stated otherwise, or otherwise understood within the context as used, is generally intended to convey that certain features, elements and/or steps are optional. Thus, such conditional language is not generally intended to imply that features, elements and/or steps are in any way required. The terms “comprising,” “including,” “having,” and the like are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Any methods disclosed herein need not be performed in the order recited. The methods disclosed herein include certain actions taken by a practitioner; however, they can also include any third-party instruction of those actions, either expressly or by implication.

Some or all of the methods and tasks described herein may be performed and fully automated by a computer system. A diagnostic test system according to the present disclosure can include a computer system that may, in some cases, include multiple distinct computers or computing devices (for example, physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (for example, solid state storage devices, disk drives, etc.). The various functions disclosed herein may be embodied in such program instructions, and/or may be implemented in application-specific circuitry (for example, ASICs or FPGAs) of the computer system. Where the computer system includes multiple computing devices, these devices may, but need not, be co-located. The results of the disclosed methods and tasks may be persistently stored by transforming physical storage devices, such as solid-state memory chips and/or magnetic disks, into a different state. The computer system may be a cloud-based computing system whose processing resources are shared by multiple distinct business entities or other users.

While the above detailed description has shown, described, and pointed out novel features, it can be understood that various omissions, substitutions, and changes in the form and details of the devices, systems, and methods can be made without departing from the spirit of the present disclosure. As can be recognized, certain portions of the description herein can be embodied within a form that does not provide all of the features and benefits set forth herein, as some features can be used or practiced separately from others. Consequently, it is not intended that the present disclosure be limited to the specific embodiments disclosed herein, but that it covers all modifications and alternatives coming within the true scope and spirit of the present disclosure.

1. A diagnostic test device comprising:
a cartridge body comprising a sample preparation reservoir; and
a diagnostic test reservoir coupled to the cartridge body, the diagnostic test reservoir comprising at least one chamber configured to receive a fluid from the sample preparation reservoir at a first section of the at least one chamber, one or more capillary grooves along an inner surface of the at least one chamber, the one or more capillary grooves configured to promote flow of the fluid toward a second section of the at least one chamber.

2. The diagnostic test device of claim 1, wherein the one or more capillary grooves are configured to inhibit droplets of the fluid from adhering to the inner surface in the first section of the at least one chamber when the fluid is dispensed into the at least one chamber from the sample preparation reservoir.

3. The diagnostic test device of claim 1, wherein the one or more capillary grooves are configured to increase a volume of the fluid that is collected in the second section of the at least one chamber.

4. (canceled)

5. The diagnostic test device of claim 1, wherein the flow of fluid is downward from the first section toward the second section, and wherein the second section comprises a closed end.

6. (canceled)

7. The diagnostic test device of claim 1, further comprising a seal between the sample preparation reservoir and the at least one chamber, the seal configured to prevent movement of the fluid between the sample preparation reservoir and the at least one chamber, and further comprising a dispensing mechanism configured to break the seal to allow movement of the fluid from the sample preparation reservoir into the at least one chamber.

8. (canceled)

9. The diagnostic test device of claim 1, wherein the diagnostic test device includes the fluid, wherein the fluid comprises a water-based buffer solution comprising at least one of an RBCC, a GRBS, and SDS, wherein the at least one chamber comprises a plastic, and wherein the plastic comprises polypropylene.

10. (canceled)

11. (canceled)

12. The diagnostic test device of claim 1, wherein the sample preparation reservoir is configured to receive a test sample, and wherein at least a portion of the fluid and at least a portion of the test sample is configured to move from the sample preparation reservoir to the at least one chamber.

13.-16. (canceled)

17. The diagnostic test device of claim 1, wherein the one or more capillary grooves are configured to facilitate movement of the fluid into contact with a lyophilized reagent in the second section of the at least one chamber.

18. (canceled)

19. The diagnostic test device of claim 1, wherein the one or more capillary grooves comprise a plurality of spaced apart valleys along the inner surface of the at least one chamber, each of the spaced apart valleys comprising a curved cross-section.

20. The diagnostic test device of claim 19, wherein the curved cross-section comprises a smooth arc.

21. The diagnostic test device of claim 19, wherein each of the plurality of spaced apart valleys comprises three inflection points.

22. The diagnostic test device of claim 19, wherein each of the plurality of spaced apart valleys comprises three curvatures.

23. The diagnostic test device of claim 19, wherein each of the plurality of spaced apart valleys comprises two convex portions separated by a concave portion.

24. The diagnostic test device of claim 19, wherein the transitions between the inner surface of the at least one chamber and the plurality of spaced apart valleys comprise rounded edges.

25. The diagnostic test device of claim 19, wherein a valley of the plurality of spaced apart valleys comprises a semicircular or semielliptical cross-sectional shape.

26. The diagnostic test device of claim 19, wherein the plurality of spaced apart valleys are separated by a planar portion of the inner surface of the at least one chamber.

27. The diagnostic test device of claim 19, wherein a portion of the inner surface in the second section of the at least one chamber forms a continuous circumferential surface.

28. The diagnostic test device of claim 19, wherein a portion of the inner surface in the second section of the at least one chamber forms a continuously curved surface.

29. The diagnostic test device of claim 19, wherein the inner surface forms a closed perimeter in the at least one chamber.

30. The diagnostic test device of claim 19, wherein a portion of the inner surface terminates in a smooth arc in the second section of the at least one chamber.

31. The diagnostic test device of claim 30, wherein a portion of the inner surface is continuous between the first section of the at least one chamber and the smooth arc in the second section of the at least one chamber.

32. The diagnostic test device of claim 19, wherein the at least one chamber further comprises a window region below ends of the plurality of spaced apart valleys.

33. The diagnostic test device of claim 19, wherein the at least one chamber further comprises a window region that does not include a valley of the plurality of spaced apart valleys.

34. The diagnostic test device of claim 19, wherein a valley of the plurality of spaced apart valleys is tapered along a portion of its height.

35. The diagnostic test device of claim 34, wherein the valley of the plurality of spaced apart valleys begins tapering at a height between the first section and the second section.

36. The diagnostic test device of claim 19, wherein an end of a valley of the plurality of spaced apart valleys has a semicircular profile.

37. The diagnostic test device of claim 19, wherein an end of a valley of the plurality of spaced apart valleys has a tapered profile.

38. The diagnostic test device of claim 19, wherein a first valley of the plurality of spaced apart valleys extends a first distance toward the second section of the at least one chamber and a second valley of the plurality of spaced apart valleys extends a second distance toward the second section of the at least one chamber, the second distance longer than the first distance.

39. The diagnostic test device of claim 19, wherein a valley of the plurality of spaced apart valleys has a different cross-sectional shape in the first section of the at least one chamber than the cross-sectional shape at an end of the valley.

40. A method of performing a diagnostic test using a diagnostic test device, the diagnostic test device comprising a sample preparation reservoir and a diagnostic test reservoir, the method comprising:
dispensing a fluid from the sample preparation reservoir into at least one chamber of the diagnostic test reservoir, one or more capillary grooves along an inner surface of the at least one chamber, the one or more capillary grooves configured to promote flow of the fluid toward a section of the at least one chamber;
performing an amplification reaction in the at least one chamber; and
detecting a presence or absence of an analyte of interest in the at least one chamber.

41.-54. (canceled)
